(19) United States
(12) Patent Application Publication
(10) Pub. No.: US 2026/0277683 A1
(43) Pub. Date: Sep. 17, 2026

(54) GRAPH-BASED MODELS WITH INTERFACE NODES

(71) Applicant: Infosys Limited, Bangalore (IN)

(72) Inventor: Steven SCHILDERS, Columbus, IN (US)

(73) Assignees: Infosys Limited, Bangalore (IN); InvertIT Inc., Columbus, IN (US)

(21) Appl. No.: 19/081,884

(22) Filed: Mar. 17, 2025

(51) Int. Cl. G06F 9/50

(52) U.S. Cl. CPC G06F 9/5027

(57) ABSTRACT

An overlay system is provided that includes a storage element and processing circuitry coupled thereto. The storage element stores an executable graph-based model having a plurality of active nodes, a plurality of interface nodes, and a plurality of overlay nodes. Each overlay node extends functionality of at least one interface node that defines a reusable structure for two or more active nodes. The processing circuitry receives a stimulus and identifies a first plurality of active nodes. The processing circuitry determines, based on the first plurality of active nodes, a first interface node defining a reusable structure for the first plurality of active nodes. The processing circuitry determines a first overlay node associated with the first interface node. The processing circuitry executes an operation associated with the stimulus based on the first plurality of active nodes, the first interface node, and the first overlay node.

### CROSS-REFERENCE TO RELATED APPLICATIONS

Various embodiments of the present disclosure relate generally to graph-based models. More specifically, various embodiments of the present disclosure relate to facilitation of interface nodes in executable graph-based models.

### BACKGROUND

Graph-based models have emerged as a powerful paradigm for representing and processing complex systems across various domains. These models typically consist of nodes, represented as vertices, and edges that define the relationships or connections between these nodes. In addition to this foundational structure, modern graph-based models often include overlay nodes, which incorporate processing logic that can be executed on data stored at the nodes. This combination of data and processing logic enables the implementation of a wide array of real-world systems, ranging from social networks and recommendation engines to logistics optimization and network security frameworks.

In real-world scenarios, the systems implemented using graph-based models are often intricate, involving large datasets and complex interdependencies among nodes. The overlay nodes, with their corresponding processing logic, play a crucial role in managing and executing operations on this data. Frequently, similar operations need to be performed across multiple nodes within the system. To address this, the reuse of overlay nodes is an effective approach, as it allows the same processing logic to be applied across different parts of the graph. This reuse not only enhances efficiency but also reduces the need for redundant implementation of processing logic for each node.

However, challenges arise when the nodes within a graph are disparate, meaning they have no inherent relationship or connection. In such cases, sharing or inheritance of overlay nodes becomes less desirable and may introduce unnecessary complexity. The lack of a relationship between nodes can complicate the reuse of overlays, potentially leading to inefficiencies or reduced clarity in system design.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating interface nodes that allow reusability of data and processing logic in executable graph-based models are provided substantially as shown in, and described in connection with, at least one of the figures.

The methods and systems described herein provide an overlay system. The overlay system includes processing circuitry and a storage element coupled to the processing circuitry. The storage element is configured to store an executable graph-based model that includes a plurality of active nodes, a plurality of interface nodes, and a plurality of overlay nodes. Each overlay node extends functionality of at least one interface node. The at least one interface node defines a reusable structure for two or more active nodes of the plurality of active nodes. The processing circuitry is configured to receive a stimulus associated with the overlay system. The processing circuitry is further configured to identify, based on the stimulus, from the plurality of active nodes, a first plurality of active nodes. The processing circuitry is further configured to determine, based on the first plurality of active nodes, a first interface node defining a first reusable structure for the first plurality of active nodes. The processing circuitry is further configured to determine a first overlay node associated with the first interface node. The processing circuitry is further configured to execute an operation associated with the stimulus based on the first plurality of active nodes, the first interface node, and the first overlay node.

In some embodiments, the first interface node is determined further based on an absence of an overlay node, having a functionality that conforms to the operation associated with the stimulus, being associated with the first plurality of active nodes.

In some embodiments, the first overlay node is determined based on processing logic associated therewith conforming to the operation associated with the stimulus.

In some embodiments, the executable graph-based model further includes a plurality of interface utility nodes, with each interface utility node being associated with an active node of the plurality of active nodes. Each interface utility node acts as a medium between the associated active node and one or more interface nodes, of the plurality of interface nodes, that define one or more reusable structures for the associated active node, respectively.

In some embodiments, the processing circuitry is further configured to determine, from the plurality of interface utility nodes, a first plurality of interface utility nodes associated with the first plurality of active nodes and the first interface node. The first plurality of interface utility nodes act as a medium between the first plurality of active nodes and the first interface node. The operation is executed further based on the first plurality of interface utility nodes.

In some embodiments, the first interface node includes an overlay manager configured to manage the association between the first interface node and the first overlay node. The processing circuitry is further configured to provide, using the overlay manager, a plurality of attribute values associated with the first interface node to the first overlay node. The plurality of attribute values include a set of attribute values associated with at least one of the first plurality of active nodes. The operation is executed further based on the plurality of attribute values.

In some embodiments, the first interface node includes an interface manager configured to facilitate reusability of the first interface node by the first plurality of active nodes. The processing circuitry is further configured to use the interface manager to acquire, from a first active node of the first plurality of active nodes, a first set of attribute values. The processing circuitry is further configured to use the interface manager to map a first attribute ontology of the first active node to a second attribute ontology of the first interface node. The processing circuitry is further configured to use the interface manager to assign, based on the mapping, the first set of attribute values of the first active node to a first set of attributes associated with the first interface node. The operation is executed further based on the assigned first set of attribute values.

In some embodiments, the operation is executed further based on an application of the first overlay node on the assigned first set of attribute values.

In some embodiments, an output of the operation includes a second set of attribute values. The processing circuitry is further configured to use the interface manager to assign, based on the mapping, the second set of attribute values to a second set of attributes of the first active node.

In some embodiments, the processing circuitry is further configured to identify, based on the stimulus, from the plurality of overlay nodes and the plurality of interface nodes, a second overlay node and a second interface node, respectively. The second interface node defines a reusable structure for a second plurality of active nodes that includes at least a second active node of the first plurality of active nodes. The second overlay node is configured to extend functionality of the second interface node. The operation is executed further based on the second overlay node and the second interface node.

In some embodiments, the first interface node is one of a group consisting of a stateless interface node or a stateful interface node.

In some embodiments, based on the first interface node being the stateless interface node, an output of the operation is stored with the first plurality of active nodes.

In some embodiments, based on the first interface node being the stateful interface node, an output of the operation is stored with the first interface node.

In some embodiments, the first overlay node is one of a group consisting of a stateful overlay node or a stateless overlay node. The first interface node is one of a group consisting of a stateless interface node or a stateful interface node. Based on the first overlay node being the stateful overlay node and the first interface node being the stateful interface node, an output of the operation is stored with the first overlay node. Based on the first overlay node being the stateful overlay node and the first interface node being the stateless interface node, the output of the operation is stored with the first plurality of active nodes. Based on the first overlay node being the stateless overlay node and the first interface node being the stateful interface node, the output of the operation is stored with the first interface node. Based on the first interface node being a stateless interface node and the first overlay node being the stateless overlay node, the output of the operation is stored with the first plurality of active nodes.

In some embodiments, the processing circuitry is further configured to identify, based on the first interface node, from the plurality of interface nodes, a third interface node that defines a reusable structure for the first interface node. The processing circuitry is further configured to determine, from the plurality of overlay nodes, a third overlay node associated with the third interface node. The operation is executed further based on the third interface node and the third overlay node.

In some embodiments, the executable graph-based model further includes a plurality of interface utility nodes. The processing circuitry is further configured to determine a second interface utility node, from the plurality of interface utility nodes, associated with the first interface node. The second interface utility node acts as a medium between the first interface node and the third interface node.

In some embodiments, based on the third interface node defining the reusable structure for the first interface node and the association of the third interface node with the third overlay node, the processing circuitry is further configured to execute processing logic of the third overlay node on the first plurality of active nodes.

In some embodiments, the processing circuitry is further configured to identify, for processing the stimulus, from the plurality of interface nodes, one or more interface nodes inherited by the first interface node. The operation is executed further based on the one or more interface nodes.

In some embodiments, the one or more interface nodes are associated with one or more overlay nodes of the plurality of overlay nodes, respectively. The operation is executed further based on the one or more overlay nodes associated with the one or more interface nodes.

In some embodiments, prior to the execution of the operation, the processing circuitry is further configured to determine whether at least one of a group consisting of: the first interface node, the first plurality of active nodes, or the first overlay node are unloaded from the executable graph-based model. The processing circuitry is further configured to load, based on the determination of at least one of the group consisting of: the first interface node, the first plurality of active nodes, or the first overlay node being unloaded from the executable graph-based model, at least one of the group consisting of: the first interface node, the first plurality of active nodes, or the first overlay node, in the executable graph-based model.

In some embodiments, the first interface node is further associated with a second overlay node of the plurality of overlay nodes. A functionality of the second overlay node conforms with the operation associated with the stimulus. The operation is executed further based on the second overlay node.

In some embodiments, an active node of the first plurality of active nodes is one of a group consisting of an edge node, a vertex node, a role node, or an overlay node.

In some embodiments, an active node of the first plurality of active nodes is a generic node, and the first interface node is a generic interface node.

In some embodiments, an active node of the first plurality of active nodes is a run-time node including (i) a node template that is a predefined node structure and (ii) a node instance that is an implementation of the node template. The first interface node is a run-time interface node having (i) an interface node template that is a predefined interface node structure and (ii) an interface node instance that is an implementation of the interface node template.

In some embodiments, the processing circuitry is further configured to load the run-time node based on loading of corresponding node template and corresponding node instance. The processing circuitry is further configured to load the run-time interface node based on loading of the interface node template and the interface node instance.

In some embodiments, a method is provided. The method comprises receiving, by the processing circuitry, a stimulus associated with an overlay system. An executable graph-based model is stored in a storage element of the overlay system. The executable graph-based model includes a plurality of active nodes, a plurality of interface nodes, and a plurality of overlay nodes, with each overlay node extending functionality of at least one interface node, the at least one interface node defining a reusable structure for two or more active nodes of the plurality of active nodes. The method further comprising identifying, by the processing circuitry, a first plurality of active nodes from the plurality of active nodes based on the stimulus. The method further comprising determining, by the processing circuitry, based on the first plurality of active nodes, a first interface node defining a first reusable structure for the first plurality of active nodes. The method further comprising determining, by the processing circuitry, a first overlay node associated with the first interface node. The method further comprising executing, by the processing circuitry, an operation associated with the stimulus based on the first plurality of active nodes, the first interface node, and the first overlay node.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a graph that illustrates a composition of an executable graph-based model, consistent with disclosed embodiments of the present disclosure;

FIG. 2 is a block diagram that illustrates a system environment of an overlay system for execution, management, and configuration of the executable graph-based model, consistent with disclosed embodiments of the present disclosure;

FIG. 3A is a block diagram that illustrates a standard structure of a generic node within the executable graph-based model, consistent with disclosed embodiments of the present disclosure;

FIG. 3B is a block diagram that illustrates a standard structure of a run-time node within the executable graph-based model, consistent with disclosed embodiments of the present disclosure;

FIG. 4A is a block diagram that illustrates a standard structure of an interface node within the executable graph-based model, consistent with disclosed embodiments of the present disclosure;

FIG. 4B is a block diagram that illustrates a standard structure of a run-time interface node within the executable graph-based model, consistent with disclosed embodiments of the present disclosure;

FIG. 5A is a block diagram that illustrates an executable interface node within the executable graph-based model, consistent with disclosed embodiments of the present disclosure;

FIG. 5B is a block diagram that illustrates an executable run-time interface node within the executable graph-based model, consistent with disclosed embodiments of the present disclosure;

FIGS. 6A and 6B are schematic diagrams that, collectively, illustrate implementation of a plurality of interface nodes in conjunction with the generic nodes, consistent with disclosed embodiments of the present disclosure, consistent with disclosed embodiments of the present disclosure;

FIG. 7 is a graph that illustrates implementation of a plurality of interface nodes in conjunction with the run-time nodes, consistent with disclosed embodiments of the present disclosure;

FIG. 8 is a block diagram that illustrates a composition of the executable interface node that enables persistent storage of data and processing logic associated therewith, consistent with disclosed embodiments of the present disclosure;

FIGS. 9A-9C, collectively, illustrate a graph that depicts an exemplary implementation of the executable graph-based model, consistent with disclosed embodiments of the present disclosure;

FIG. 10 shows an example computing system for carrying out methods of the present disclosure, consistent with disclosed embodiments of the present disclosure; and

FIG. 11 illustrates a flowchart of a method for implementing an interface node within the executable graph-based model, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Graph-based models have become an essential framework for representing and analyzing complex systems across a wide range of industries and applications. These models are built upon a structure of nodes, which serve as vertices, and edges that represent the connections or relationships between these nodes. Beyond this fundamental structure, contemporary graph-based models increasingly incorporate overlay nodes. These overlay nodes are designed to include processing logic that operates on data stored at the nodes, enabling the implementation of advanced computational systems. Applications for such systems are vast, encompassing fields like supply chain optimization, fraud detection, data analysis, and dynamic network modeling.

The complexity of real-world systems often results in large-scale graphs with intricate interconnections among nodes. Overlay nodes, by embedding specific processing logic, are instrumental in executing a variety of operations across these graphs. To ensure operational efficiency, it is common to reuse overlay nodes for performing similar tasks on multiple nodes within the graph. This strategy streamlines system development by avoiding the duplication of processing logic and ensures consistency in operations, especially when managing highly interdependent data structures.

Despite the advantages of overlay reuse, challenges arise when dealing with disparate nodes i.e., nodes that lack direct relationships or connections within the graph. Sharing or inheriting overlays among such nodes can introduce unnecessary complications and reduce the clarity of system design. Moreover, the lack of inherent relationships between these nodes limits the practical benefits of overlay reuse.

The present disclosure is directed to facilitation of interface nodes that defines a reusable structure in an executable graph-based model of an overlay system. The executable graph-based model is a customized hypergraph with hyper-edges that are realized by way of executable nodes. Each executable node is associated with a particular node-type. For example, an edge node corresponds to a base node with an edge node-type. Nodes (for example, base nodes and executable nodes) are connected with other nodes by way of roles included in an edge node therebetween. In some embodiments, roles are represented by way of nodes of role node-type. A role node between two nodes may be indicative of a context regarding an association therebetween. The executable graph-based model also includes a plurality of overlay nodes that incorporate in-situ features in the overlay system. Each overlay node is associated with one or more nodes (for example, a vertex node, an edge node, or the like) of the executable graph-based model and includes a corresponding processing logic that when executed implements a functionality thereof on the associated nodes. Hence, the processing logic is implemented within the executable graph-based model and is not required to be retrieved from any external system.

The overlay system disclosed herein facilitates implementation of the interface nodes in the executable graph-based model. The executable graph-based model may include a plurality of nodes (for example, a plurality of active nodes). Many of the active nodes may be disparate i.e., they may not have any commonality between them. In many instances, such active nodes may require common data or processing logic. However, sharing or inheritance of data and/or processing logic among disparate nodes may cause unnecessary complications within the overlay system. Hence, sharing of data and processing logic among the active nodes may be facilitated by way of an interface node. The interface node may be associated with two or more active nodes. Further, overlay nodes or data associated with the interface node may be accessible to the active nodes associated therewith. To summarize, the interface node may form a reusable structure for the active nodes associated therewith. Moreover, the interface node may be associated with any number of active nodes and vice versa. Further, each active node may be associated with the interface node by way of an interface utility node. The interface utility node may be a part of a logical structure of the active node and may act as a medium between the active node and the interface node.

Thus, data and/or processing logic that may have to be shared among disparate active nodes may be defined in association with an interface node associated with such active nodes. This allows for a unique instantiation of the data and/or processing logic that is to be reused, shared, or defined commonly. Also, such an approach to implement the interface node in conjunction with the disparate active nodes allows for simplification of structure of the executable graph-based model based on a significant reduction in data duplication and redundancy. Additionally, operations associated with retrieval of duplicate and redundant data may be significantly reduced. This may lead to significant improvement in throughput and turnaround time. Therefore, the overlay system may exhibit optimal utilization of the resources (for example, the processing capability, storage capacity, time, or the like).

### Figure description

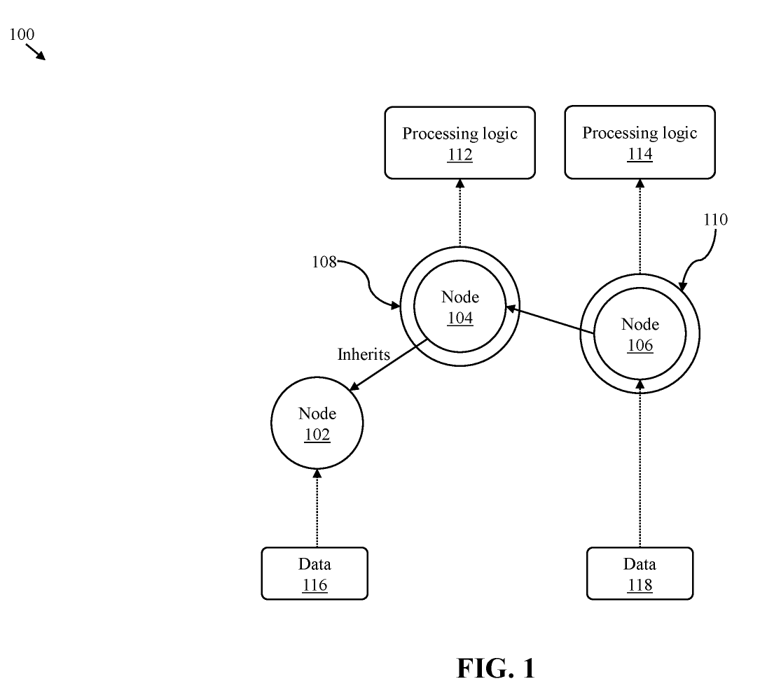

FIG. 1 is a graph that illustrates a composition of an executable graph-based model 100, consistent with disclosed embodiments of the present disclosure. Referring to FIG. 1, the executable graph-based model 100 is generally formed of a data structure (e.g., a graph-based model or a graphical model) comprising a plurality of nodes 102-106 which can be functionally extended with processing logic via the use of overlays. For example, as shown in FIG. 1, the nodes 104 and 106 are functionally extended with processing logic via the use of overlay nodes 108 and 110, respectively. Although not shown, the node 102 can be similarly extended with processing logic via the use of one or more overlays. Each overlay includes processing logic, such as processing logic 112 and 114 which are associated with the overlay nodes 108 and 110, respectively. At run-time, data, such as data 116 and 118, is associated with the nodes 102 and 106, respectively. Further, the overlay nodes 108 and 110 of the nodes 104 and 106, respectively, provide the functionality to respond to stimuli and interact with, manipulate, or otherwise process the data based on the stimuli. Further, the node 104 inherits the node 102, and hence, also inherits the data 116 which is associated with the node 102. In some embodiments, the node 102 may be extended to have one or more overlays. In such embodiments, the node 104 may further inherit the overlays of the node 102.

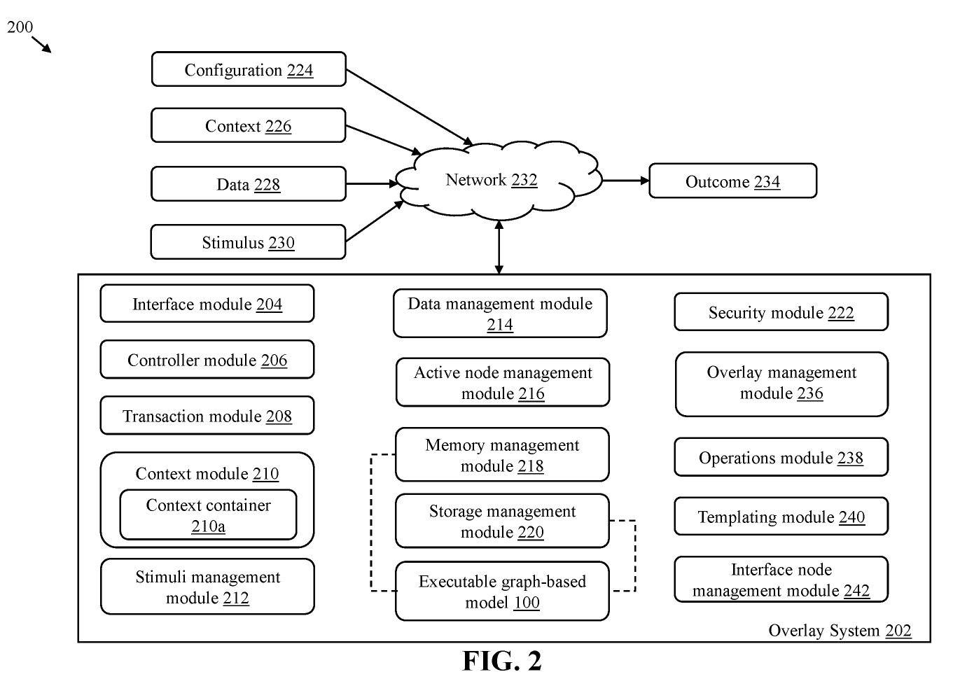

Each element within the executable graph-based model 100 (both the data and the processing functionality) is implemented by way of a node. A node forms the fundamental building block of all executable graph-based models. A node may be an executable node. A node that is extended by way of an overlay node forms an executable node. One or more nodes are extended to include overlays in order to form the executable graph-based model 100. As such, the executable graph-based model 100 includes one or more nodes that can be dynamically generated, extended, or processed by one or more other modules within an overlay system (shown in FIG. 2). Throughout the description, the terms “overlay node” and “overlay” are used interchangeably.

Notably, the structure and functionality of the data processing are separate from the data itself when offline (or at rest) and are combined dynamically at run-time. The executable graph-based model 100 thus maintains the separability of the data and the processing logic when offline. Moreover, by integrating the data and the processing logic within a single model, processing delays or latencies are reduced because the data and the processing logic exist within the same logical system. Therefore, the executable graph-based model 100 applies to a range of time-critical systems where efficient processing of the stimuli is required.

FIG. 2 is a block diagram that illustrates a system environment 200 of an overlay system 202 for execution, management, and configuration of the executable graph-based model 100, consistent with disclosed embodiments of the present disclosure. Referring to FIG. 2, the overlay system 202 includes the executable graph-based model 100. The overlay system 202 further includes an interface module 204, a controller module 206, a transaction module 208, a context module 210, a stimuli management module 212, a data management module 214, an active node management module 216, a memory management module 218, a storage management module 220, and a security module 222. FIG. 2 further shows a configuration 224, a context 226, data 228, a stimulus 230, a network 232, and an outcome 234. Additionally, the overlay system 202 of the present disclosure includes an overlay management module 236, an operations module 238, a templating module 240, and an interface node management module 242. In some embodiments, all the modules of the overlay system 202 except for the executable graph-based model 100 may collectively form processing circuitry that facilitates operations associated with a plurality of active nodes of the executable graph-based model 100. The plurality of active nodes may include generic nodes and run-time nodes.

A generic node may refer to a node, in the executable graph-based model 100, with an edge node-type, a role node-type, an overlay node-type, or a vertex node-type. A generic node with the vertex node-type is coupled to another generic node with the vertex node-type by way of a node with the edge node-type indicative of a role of the generic node. A run-time node may include a node template and a node instance. The node template may be a predefined node structure and the node instance may be an implementation of the predefined node structure. The run-time node may have an edge node-type, a role node-type, an overlay node-type, or a vertex node-type. A run-time node with the vertex node-type is coupled to other generic run-time node with the vertex node-type by way of a node with the edge node-type indicative of a role of the run-time node.

The overlay system 202 may include suitable logic, circuitry, interfaces, and/or code, executable by the circuitry, that may be configured to facilitate one or more operations associated with the active nodes in the executable graph-based model 100.

The interface module 204 may include suitable logic, circuitry, interfaces, and/or code, executable by the circuitry, configured to provide a common interface between internal modules of the overlay system 202 and/or external sources. The interface module 204 provides an application programmable interface (API), scripting interface, or any other suitable mechanism for interfacing externally or internally with any module of the overlay system 202. The configuration 224, the context 226, the data 228, and the stimulus 230 may be received by the interface module 204 via the network 232. Similarly, outputs (e.g., the outcome 234) produced by the overlay system 202 are passed by the interface module 204 to the network 232 for consumption or processing by external systems. In one embodiment, the interface module 204 supports one or more messaging patterns or protocols such as the simple object access protocol (SOAP), the representational state transfer (REST) protocol, or the like. The interface module 204 thus allows the overlay system 202 to be deployed in any number of application areas, operational environments, or architecture deployments. Although not illustrated in FIG. 2, the interface module 204 is communicatively coupled (e.g., connected either directly or indirectly) to one or more other modules or elements within the overlay system 202 (such as the controller module 206, the context module 210, the executable graph-based model 100, or the like). In one embodiment, the interface module 204 is communicatively coupled (e.g., connected either directly or indirectly) to one or more overlays within the executable graph-based model 100.

The controller module 206 may include suitable logic, circuitry, interfaces, and/or code, executable by the circuitry, configured to handle and process interactions and executions within the overlay system 202. As will be described in more detail below, stimuli (such as the stimulus 230) and their associated contexts (such as the context 226) provide the basis for all interactions within the executable graph-based model 100. Processing of such stimuli may lead to execution of processing logic associated with one or more overlays within the executable graph-based model 100. The processing of the stimuli within the overlay system 202 may be referred to as a system transaction (namely, transaction). The processing and execution of stimuli (and associated overlay execution) within the overlay system 202 is handled by the controller module 206. The controller module 206 manages all received input stimuli (e.g., the stimulus 230) and processes them based on a corresponding context (e.g., the context 226). The context 226 determines the priority that is to be assigned to the processing of the corresponding stimulus by the controller module 206 or the context module 210. This allows each stimulus to be configured with a level of importance and prioritization within the overlay system 202.

The controller module 206 may maintain the integrity of the modules within the overlay system 202 before, during, and after a system transaction. The transaction module 208, which is associated with the controller module 206, is responsible for maintaining the integrity of the overlay system 202 through the lifecycle of a transaction. Maintaining system integrity via the controller module 206 and the transaction module 208 allows a transaction to be rolled back in an event of an expected or unexpected software or hardware fault or failure. The controller module 206 is configured to handle the processing of the stimulus 230 and transactions through architectures such as parallel processing, grid computing, priority queue techniques, or the like. In one embodiment, the controller module 206 and the transaction module 208 are communicatively coupled (e.g., connected either directly or indirectly) to one or more overlays within the executable graph-based model 100.

As stated briefly above, the overlay system 202 utilizes a context-driven architecture, whereby the stimulus 230 within the overlay system 202 is associated with the context 226 which is used to adapt the handling or processing of the stimulus 230 by the overlay system 202. That is to say that the handling or processing of the stimulus 230 is done based on the context 226 associated therewith. Hence, the stimulus 230 is a contextualized stimulus. The context 226 may include details such as username, password, access token, device information, time stamp, one or more relevant identifiers (IDs), or the like, that are required for processing of the stimulus 230 within the executable graph-based model 100. Each context within the overlay system 202 may be extended to include additional information that is required for the processing of the stimulus (e.g., a query, a command, or an event).

The context module 210 may include suitable logic, circuitry, interfaces, and/or code, executable by the circuitry, configured to manage the handling of contexts within the overlay system 202. The context module 210 is responsible for processing any received contexts (e.g., the context 226) and translating the received context to an operation execution context. In some examples, the operation execution context is larger than the received context because the context module 210 supplements the received context with further information necessary for the processing of the received context. The context module 210 passes the operation execution context to one or more other modules within the overlay system 202 to drive communication of data associated with the operation execution context. Contexts within the overlay system 202 can be external or internal. While some contexts apply to all application areas and problem spaces, some applications may require specific contexts to be generated and used to process the received stimulus 230. As will be described in more detail below, the executable graph-based model 100 is configurable (e.g., via the configuration 224) so as only to execute within a given execution context for a given stimulus.

As shown, the context module 210 includes a context container 210a that includes a set of defined contexts. Each defined context of the set of defined contexts pertains to a context that is associated with one or more operations for facilitating application and management of the plurality of nodes (for example, the active nodes) in the overlay system 202. That is to say that, one or more contexts of the set of defined contexts are indicative of the one or more operations to be executed by way of one or more active nodes in the overlay system 202. The one or more operations are executed when a context of a corresponding stimuli matches one of the set of defined contexts.

The stimuli management module 212 may include suitable logic, circuitry, interfaces, and/or code, executable by the circuitry, configured to process externally received stimuli (e.g., the stimulus 230) and any stimuli generated internally from any module within the overlay system 202. The stimuli management module 212 is communicatively coupled (e.g., connected either directly or indirectly) to one or more overlays within the executable graph-based model 100 to facilitate the processing of stimuli within the executable graph-based model 100. The overlay system 202 utilizes different types of stimuli such as a command (e.g., a transactional request), a query, or an event received from an external system such as an Internet-of-Things (IoT) device. As previously stated, a stimulus (such as the stimulus 230) can be either externally or internally generated. In an example, the stimulus 230 may be a message that is internally triggered (e.g., generated) from any of the modules within the overlay system 202. Such internal generation of the stimulus 230 indicates that something has happened within the overlay system 202 and subsequent handling by one or more other modules within the overlay system 202 may be required. Internal stimulus 230 can also be triggered (e.g., generated) from the execution of processing logic associated with overlays within the executable graph-based model 100. In another example, the stimulus 230 may be externally triggered and may be generated based on an input received via a user interface associated with the controller module 206. The externally triggered stimulus 230 may be received in the form of a signal, a textual, audio, or visual input. The externally triggered stimulus 230 may be associated with the intent of a user to execute an operation indicated by the stimulus 230. The operation is executed in accordance with information included in the context 226 associated with the stimulus 230.

The stimuli management module 212 may receive the stimuli (such as the stimulus 230) in real-time or near-real-time and communicate the received stimuli to one or more other modules or nodes of the executable graph-based model 100. In some examples, the stimuli are scheduled in a batch process. The stimuli management module 212 utilizes any suitable synchronous or asynchronous communication architectures or approaches in communicating the stimuli (along with associated information). The stimuli within the overlay system 202 are received and processed (along with a corresponding context) by the stimuli management module 212, which then determines the processing steps to be performed for the communication of data associated with each stimulus.

In one embodiment, the stimuli management module 212 processes the received stimuli in accordance with a predetermined configuration (e.g., the configuration 224) or dynamically determines what processing needs to be performed based on the contexts associated with the stimuli and/or based on a state of the executable graph-based model 100. The state of the executable graph-based model 100 refers to the current state of each node of the executable graph-based model 100 at a given point in time. The state of the executable graph-based model 100 is dynamic, and hence, may change based on processing of data by any of its nodes. In some examples, the processing of a stimulus (such as the stimulus 230) results in the generation, communication, or processing of data that further results in one or more outcomes (e.g., the outcome 234) being generated. Such outcomes are either handled internally by one or more modules in the overlay system 202 or communicated via the interface module 204 as an external outcome. In one embodiment, all stimuli and corresponding outcomes are recorded for auditing and post-processing purposes by, for example, the operations module 238 of the overlay system 202.

The data management module 214 may include suitable logic, circuitry, interfaces, and/or code, executable by the circuitry, configured to manage all data or information within the overlay system 202 (e.g., the data 228) for a given application. Operations performed by the data management module 214 include data loading, data unloading, data modeling, and data processing. The data management module 214 is communicatively coupled (e.g., connected either directly or indirectly) to one or more other modules within the overlay system 202 to complete some or all of these operations. For example, data storage is handled by the data management module 214 in conjunction with the storage management module 220.

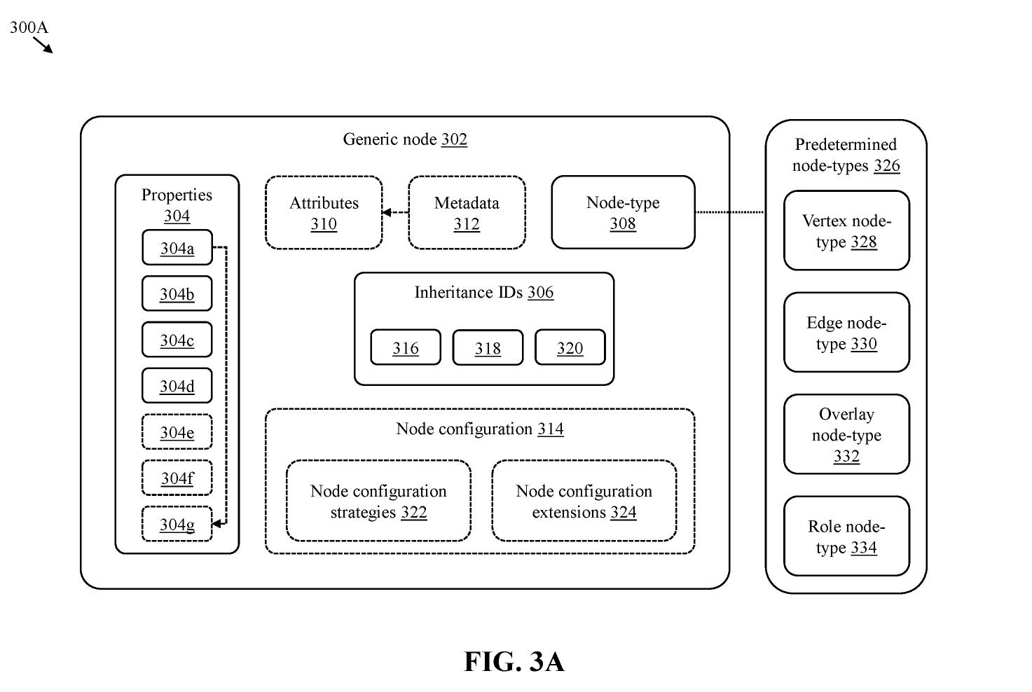

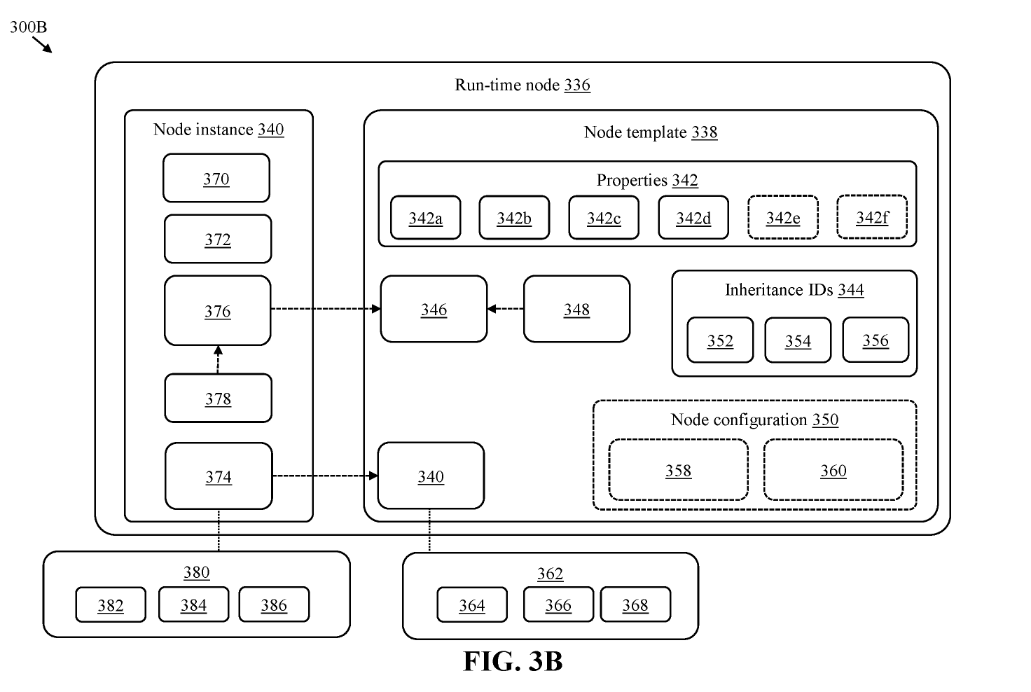

The active node management module 216 may include suitable logic, circuitry, interfaces, and/or code, executable by the circuitry, configured to manage, design, and implement the plurality of active nodes in the overlay system 202. The active nodes may include the generic nodes and the run-time nodes. Further, each active node may have a vertex node-type, an edge node-type, a role node-type, or an overlay node-type (described in conjunction with FIGS. 3A-3B). The active node management module 216 is further configured to facilitate operations associated with execution of one or more transactions using the active nodes.

The memory management module 218 may include suitable logic, circuitry, interfaces, and/or code, executable by the circuitry, configured to manage and optimize the memory usage of the overlay system 202. The memory management module 218 thus helps to improve the responsiveness and efficiency of the processing performed by one or more modules within the overlay system 202 by optimizing the memory handling performed by these modules. The memory management module 218 uses direct memory or some form of distributed memory management architecture (e.g., a local or remote caching solution). Additionally, or alternatively, the memory management module 218 deploys multiple different types of memory management architectures and solutions (e.g., reactive caching approaches such as lazy loading or a proactive approach such as write-through cache may be employed). These architectures and solutions are deployed in the form of a flat (single-tiered) or multi-tiered caching architecture where each layer of the caching architecture can be implemented using a different caching technology or architecture solution approach. In such implementations, each cache or caching tier can be configured (e.g., by the configuration 224) independent of the requirements for one or more modules of the overlay system 202. For example, data priority and an eviction strategy, such as least-frequently-used (LFU) or least-recently-used (LRU), can be configured for all or parts of the executable graph-based model 100. In one embodiment, the memory management module 218 is communicatively coupled (e.g., connected either directly or indirectly) to one or more overlays within the executable graph-based model 100.

The storage management module 220 may include suitable logic, circuitry, interfaces, and/or code, executable by the circuitry, configured to manage the temporary or permanent storage of data associated with the overlay system 202. The storage management module 220 is any suitable low-level storage device solution (such as a file system) or any suitable high-level storage technology such as another database technology (e.g., relational database management system (RDBMS) or NoSQL database). The storage management module 220 is directly connected to the storage device upon which the relevant data is persistently stored. For example, the storage management module 220 can directly address the computer-readable medium (e.g., hard disk drive, external disk drive, or the like) upon which the data is being read or written. Alternatively, the storage management module 220 is connected to the storage device via a network such as the network 232. As will be described in more detail later in the present disclosure, the storage management module 220 uses manifests to manage the interactions between the storage device and the modules within the overlay system 202. In one embodiment, the storage management module 220 is communicatively coupled (e.g., connected either directly or indirectly) to one or more overlays within the executable graph-based model 100. Throughout the description, the term ‘storage device’ is used interchangeably with the term ‘storage element’.

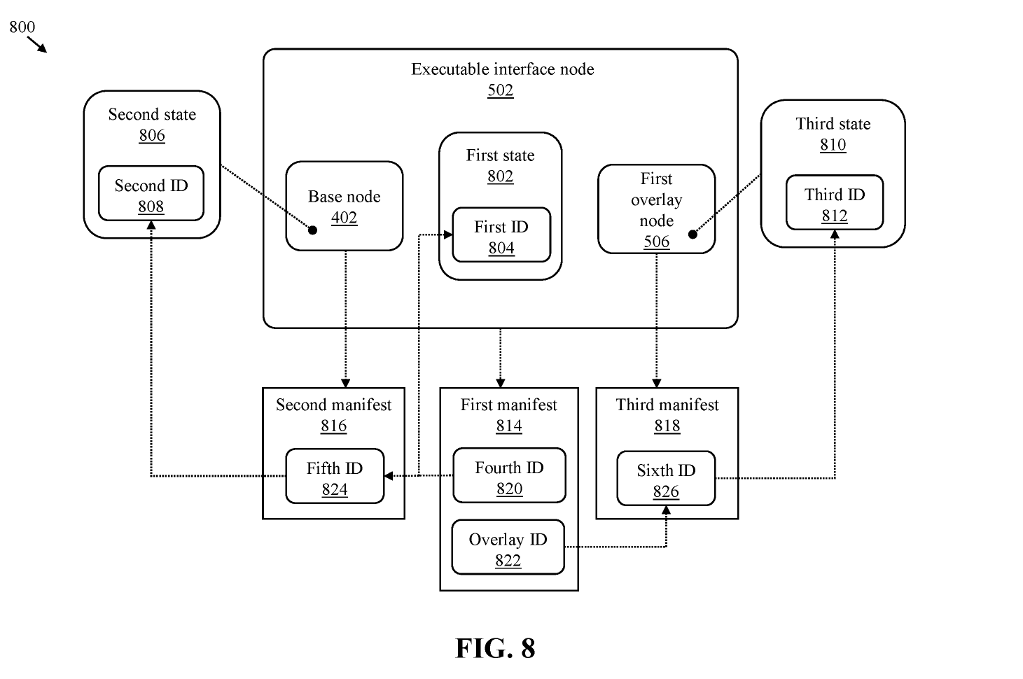

As described, storage, loading, and unloading of the executable graph-based model 100 or one or more components thereof is facilitated by the memory management module 218 and the storage management module 220. The memory management module 218 and the storage management module 220 may facilitate such operations by interacting with the storage device that stores the executable graph-based model 100. The overlay system 202 further includes a plurality of manifest storages. The manifest storages are used by the memory management module 218 and the storage management module 220 to facilitate storage of manifest states (including manifest template states and manifest instance states) of nodes. The storage element may include a primary storage and a secondary storage. The primary storage may store the executable graph-based model 100 and may also store nodes that are loaded in the executable graph-based model 100. The secondary storage may store node states, manifests, and manifest states associated with nodes that are unloaded from the executable graph-based model 100. Storage and retrieval of nodes are described in detail in conjunction with FIG. 8.

The security module 222 may include suitable logic, circuitry, interfaces, and/or code, executable by the circuitry, configured to manage the security of the overlay system 202. This includes security at a system level and a module level. Security is hardware-related, network-related, or software-related, depending on the operational environment, the architecture of the deployment, or the data and information contained within the overlay system 202. For example, if the system is deployed with a web-accessible API (as described above in relation to the interface module 204), the security module 222 can enforce a hypertext transfer protocol secure (HTTPS) protocol with the necessary certification. As a further example, if the data or information associated with the data associated with the overlay system 202 contains Personally Identifiable Information (PII) or Protected Health Information (PHI), the security module 222 can implement one or more layers of data protection to ensure that the PII or PHI are correctly processed and stored. In an additional example, in implementations whereby the overlay system 202 operates on United States of America citizen medical data, the security module 222 may enforce additional protections or policies as defined by the United States Health Insurance Portability and Accountability Act (HIPAA). Similarly, if the overlay system 202 is deployed in the European Union (EU), the security module 222 may enforce additional protections or policies to ensure that the data processed and maintained by the overlay system 202 complies with the General Data Protection Regulation (GDPR). In one embodiment, the security module 222 is communicatively coupled (e.g., connected either directly or indirectly) to one or more overlays within the executable graph-based model 100, thereby directly connecting security execution to the data/information in the executable graph-based model 100. The security module 222 thus acts as a centralized coordinator that works in conjunction with the overlay management module 236 for managing and executing security-based overlays.

The overlay management module 236 may include suitable logic, circuitry, interfaces, and/or code, executable by the circuitry, configured to manage all overlays within the overlay system 202. Operations performed by the overlay management module 236 include overlay storage management, overlay structure modeling, overlay logic creation and execution, and overlay loading and unloading (within the executable graph-based model 100). The overlay management module 236 is communicatively coupled (e.g., connected either directly or indirectly) to one or more other modules within the overlay system 202 to complete some or all of these operations. For example, overlays can be persisted in some form of physical storage using the storage management module 220 (as described in more detail below). As a further example, overlays can be compiled and preloaded into memory via the memory management module 218 for faster run-time execution.

The operations module 238 may include suitable logic, circuitry, interfaces, and/or code, executable by the circuitry, configured to track operational metrics and the behavior of all modules of the overlay system 202. Operational metrics of a module are indicative of statistics associated with the performance of the module while performing an operation (for example, communication, data processing, stimulus processing, or the like).

The templating module 240 may include suitable logic, circuitry, interfaces, and/or code, executable by the circuitry, configured to enable the overlay system 202 to implement a templated version of one or more nodes of the executable graph-based model 100. The templating module 240 may be configured to create one or more predefined templates in the executable graph-based model 100. The templating module 240 may be further configured to generate one or more node instances of the predefined node templates for the implementation of the templated version of the executable graph-based model 100. Notably, the templating module 240 ensures ontology integrity by enforcing structure and rules of a template when generating instances of the template at run-time. Ontology integrity refers to consistency, accuracy, and correctness of an ontology. Thus, the templating module 240 ensures that the consistency, accuracy, and correctness of the ontology of the executable graph-based model 100 are maintained while generating the instances of the template at run-time. The templating module 240 may be communicatively coupled (i.e., connected either directly or indirectly) to one or more nodes and/or one or more overlays within the executable graph-based model 100.

The plurality of active nodes within the overlay system 202 may include various nodes (for example, vertex nodes, edge nodes, role nodes, overlay nodes, or the like) that may be disparate nodes. Throughout the description, the term ‘disparate nodes’ refers to two or more active nodes that may not have a commonality (for example, common data, common processing logic, common operations, common purpose, or the like). The lack of commonality makes application of concepts such as inheritance, sharing, or the like impractical and complicated. Such complications associated with the overlay system 202 are resolved herein by introducing an interface node associated with the disparate nodes. The interface node may be associated with data and overlay nodes that may be shared, used, and re-used by the disparate nodes associated therewith. The executable graph-based model 100 may include a plurality of interface nodes. The interface node management module 242 may include suitable logic, circuitry, interfaces, and/or code, executable by the circuitry, configured to enable the overlay system 202 to manage one or more operations pertaining to association of the interface nodes with the active nodes as well as utilization of the interface nodes by the associated active nodes. The interface node management module 242 may be further configured to facilitate creation, update, modification, deletion, maintenance, or the like of the interface nodes within the executable graph-based model 100. The interface node management module 242 may be further configured to associate or dissociate the interface nodes with one or more active nodes.

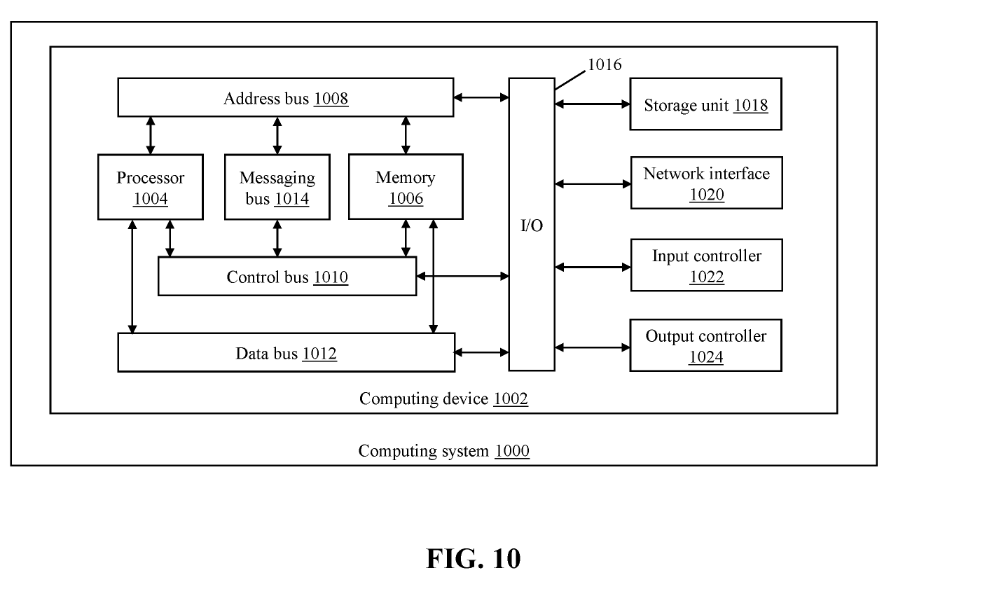

Beneficially, various features of the overlay system 202 support the processing circuitry and a computing system (shown in FIG. 10) implementing the overlay system in significantly enhancing its performance. The significant enhancement in performance may include significantly increased throughput and efficiency, as well as significantly reduced cost complexity, processing complexity, time complexity, latency, waiting time, turnaround time, or the like.

The functionality of two or more of the modules included in the overlay system 202 may be combined within a single module. Conversely, the functionality of a single module can be split into two or more further modules which can be executed on two or more devices. The modules described above in relation to the overlay system 202 can operate in a parallel, distributed, or networked fashion. The overlay system 202 may be implemented in software, hardware, or a combination of both software and hardware. Examples of suitable hardware modules include, but are not limited to, a general-purpose processor, a field programmable gate array (FPGA), and/or an application-specific integrated circuit (ASIC). Software modules can be expressed in a variety of software languages such as C, C++, Java, Ruby, Visual Basic, Python, and/or other object-oriented, procedural, or functional programming languages.

Although it is described that the overlay system 202 includes a single executable graph-based model (e.g., the executable graph-based model 100), the scope of the present disclosure is not limited to it. In other embodiments, the overlay system 202 may include more than one executable graph-based model, without deviating from the scope of the present disclosure. In such a scenario, each executable graph-based model is implemented and managed in a manner that is similar to the executable graph-based model 100.

Having described the overlay system 202 for executing and managing executable graph-based models, the description will now turn to the elements of an executable graph-based model, specifically, the concept of a node. Unlike conventional graph-based systems, all elements (e.g., data, overlays, etc.) within the executable graph-based model 100 are implemented as nodes. As will become clear, this allows executable graph-based models to be flexible, extensible, and highly configurable.

FIG. 3A is a block diagram 300A that illustrates a standard structure of a generic node 302 within the executable graph-based model 100, consistent with disclosed embodiments of the present disclosure. Referring to FIG. 3A, the generic node 302 corresponds to a generic node of the executable graph-based model 100. The generic node 302 further corresponds to the core structure of the executable graph-based model 100 and forms the foundational building block for all data and processing logic within the executable graph-based model 100. The generic node 302 includes properties 304, inheritance IDs 306, and a node-type 308. The generic node 302 optionally includes one or more attributes 310, metadata 312 associated with the attributes 310, and a node configuration 314.

The properties 304 of the generic node 302 include a unique ID 304a, a version ID 304b, a namespace 304c, and a name 304d. The properties 304 optionally include one or more icons 304e, one or more labels 304f, and one or more alternative IDs 304g. The inheritance IDs 306 of the generic node 302 include an abstract flag 316, a leaf flag 318, and a root flag 320. The node configuration 314 optionally includes one or more node configuration strategies 322 and one or more node configuration extensions 324.

The unique ID 304a is unique for each node within the executable graph-based model 100. The unique ID 304a is used to register, manage, and reference the generic node 302 within the system (e.g., the overlay system 202). In some embodiments, the one or more alternative IDs 304g are associated with the unique ID 304a to help manage communications and connections with external systems (e.g., during configuration, sending stimuli, or receiving outcomes). The version ID 304b of the generic node 302 is incremented when the generic node 302 undergoes transactional change. This allows the historical changes between versions of the generic node 302 to be tracked by modules or overlays within the overlay system 202. The namespace 304c of the generic node 302, along with the name 304d of the generic node 302, is used to help organize nodes within the executable graph-based model 100. That is, the generic node 302 is assigned a unique name 304d within the namespace 304c such that the name 304d of the generic node 302 need not be unique within the entire executable graph-based model 100, only within the context of the namespace 304c to which the generic node 302 is assigned. The generic node 302 optionally includes one or more icons 304e which are used to provide a visual representation of the generic node 302 when visualized via a user interface. The one or more icons 304e can include icons at different resolutions and display contexts such that the visualization of the generic node 302 is adapted to different display settings and contexts. The generic node 302 also optionally includes one or more labels 304f which are used to override the name 304d when the generic node 302 is rendered or visualized.

The generic node 302 supports the concept of inheritance of data and processing logic associated with any other node of the executable graph-based model 100 that is inherited by the generic node 302. This allows the behavior and functionality of the generic node 302 to be extended or derived from the inherited node of the executable graph-based model 100. The inheritance IDs 306 of the generic node 302 indicate the inheritance-based information, which may apply to the generic node 302. The inheritance IDs 306 comprise a set of Boolean flags that identify the inheritance structure of the generic node 302. The abstract flag 316 allows the generic node 302 to support the construct of abstraction. When the abstract flag 316 takes a value ‘true’, the generic node 302 is flagged as abstract that is to say that it cannot be instantiated or created within an executable graph-based model (e.g., the executable graph-based model 100). Thus, in an instance when the generic node 302 has the abstract flag 316 set to ‘true’, the generic node 302 may only form the foundation of other nodes that inherit therefrom. By default, the abstract flag 316 of the generic node 302 is set to ‘false’. The leaf flag 318 is used to indicate whether any other node may inherit from the generic node 302. If the leaf flag 318 is set to ‘true’, no other node may inherit from the generic node 302 (but unlike an abstract node, a node with the leaf flag 318 set may be instantiated and created within the executable graph-based model 100). The root flag 320 is used to indicate whether the generic node 302 inherits from any other node. If the root flag 320 is set to ‘true’, the generic node 302 does not inherit from any other node. The generic node 302 is flagged as leaf (e.g., the leaf flag 318 is set to ‘true’) and/or root (e.g., the root flag 320 is set to ‘true’), or neither (e.g., both the leaf flag 318 and the root flag 320 are set to ‘false’). It will be apparent to a person skilled in the art that a node cannot be flagged as both abstract and leaf (e.g., the abstract flag 316 cannot be set to ‘true’ whilst the leaf flag 318 is set to ‘true’).

As stated above, all elements of the executable graph-based model 100 are defined as nodes. This functionality is in part realized due to the use of a node-type. The node-type 308 of the generic node 302 is used to extend the functionality of the generic node 302. All nodes within the executable graph-based model 100 comprise a node-type that defines additional data structures and implements additional executable functionality. A node-type thus includes data structures and functionality that are common across all nodes that share that node-type. Therefore, composition of a node with a node-type improves extensibility by allowing the generation of specialized node functionalities for specific application areas. Such extensibility is not present in prior art graph-based models. As illustrated in FIG. 3A, the generic node 302 and the node-type 308 are one logical unit that is not separated in the context of an executing system at run-time (e.g., in the context of execution of an executable graph-based model).

FIG. 3A further shows the plurality of predetermined node-types 326 which provides a non-exhaustive list of node-types for the node-type 308 associated with the generic node 302. The plurality of predetermined node-types 326 includes a vertex node-type 328 and an edge node-type 330. The vertex node-type 328 (also referred to as a data node-type or a value node-type) includes common data structures and functionality related to the ‘things’ modeled in the graph (e.g., the data). The edge node-type 330 includes common data structures and functionality related to coupling/linking/associating two or more nodes. A node having the edge node-type 330 may connect two or more nodes and thus the edge node-type 330 constructs associations and connections between nodes (for example, objects or ‘things’) within the executable graph-based model 100. The edge node-type 330 is not restricted to the number of nodes that can be associated or connected by a node having the edge node-type 330. The data structures and functionality of the edge node-type 330 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween.

The plurality of predetermined node-types 326 further includes an overlay node-type 332 and a role node-type 334. As will be described in more detail below, a node with the overlay node-type 332 is used to extend the functionality of a node, such as the generic node 302, to incorporate processing logic. Unlike non-overlay nodes, an overlay node (e.g., a node having the overlay node-type 332) includes processing logic which determines the functionality of the overlay node. The processing logic of an overlay node includes a block of executable code, or instructions, which carries out one or more operations associated with the communication of data within the executable graph-based model 100. The block of executable code is pre-compiled code, code that requires interpretation at run-time, or a combination of both. Different overlay nodes provide different processing logic to realize different functionality. For example, an encryption overlay node includes an encryption technique using which an associated node is to be protected/secured and processing logic for facilitating such security/protection of the associated node.

The role node-type 334 defines a connective relationship between two nodes, for example, an edge node and a first vertex node. A node with the role node-type 334 defines a relationship without expressly defining the first vertex node to which the edge node connects. A number of roles (and thus a number of connections) that an edge node-type can have is not limited.

The one or more attributes 310 correspond to the data associated with the generic node 302 (e.g., the data represented by the generic node 302 within the executable graph-based model 100 as handled by the data management module 214). Notably, a node in the executable graph-based model 100 that is not associated with data may not have any attributes. The one or more attributes 310 represent a complex data type. Each attribute of the one or more attributes 310 is composed of an attribute behavior. Attribute behavior may be one of a standard attribute behavior, a reference attribute behavior, a derived attribute behavior, or a complex attribute behavior. The attribute behavior of each attribute defines the behavior of the corresponding attribute. The attribute behavior of each attribute may be configured by associated attribute configurations. The attribute configurations are examples of attribute configuration extensions which are node configuration extensions (e.g., they are part of the one or more node configuration extensions 324 of the generic node 302 shown in FIG. 3A). The standard attribute behavior may be configured by a standard attribute configuration, the reference attribute behavior may be configured by a reference attribute configuration, the derived attribute behavior is configured by a derived attribute configuration, and the complex attribute behavior is configured by a complex attribute configuration.

The attribute behavior defines the behavior of the corresponding attribute. The standard attribute behavior is a behavior that allows read-write access to the data of the corresponding attribute. The reference attribute behavior is a behavior that allows read-write access to the data of the corresponding attribute but restricts possible values of the data to values defined by a reference data set. The reference attribute configuration associated with the reference attribute behavior includes appropriate information to obtain a reference data set of possible values. The derived attribute behavior is a behavior that allows read-only access to data of the corresponding attribute. Also, data of the corresponding attribute is derived from other data or information, within the executable graph-based model 100 in which an executable node of the corresponding attribute is used. The data is derived from one or more other attributes associated with the node or is derived from more complex expressions depending on the application area. In one embodiment, the derived attribute configuration (which is used to configure the derived attribute behavior) includes mathematical and/or other forms of expressions (e.g., regular expressions, templates, or the like) that are used to derive the data (value) of the corresponding attribute. The complex attribute behavior is a behavior that allows the corresponding attribute to act as either a standard attribute behavior if the data of the corresponding attribute is directly set, or a derived attribute behavior if the data of the corresponding attribute is not directly set.

As shown, the generic node 302 further includes the metadata 312 (e.g., data stored as a name, a confidentiality indicator for indicating data as sensitive and/or confidential, an average processing time required for processing data, or the like) which is associated with either the generic node 302 or an attribute (for example, the one or more attributes 310) of the generic node 302. An attribute within the one or more attributes 310 may either have an independent state or a shared state. That is to say, an attribute may be a value-shared attribute or a non-value-shared attribute. An independent attribute has data that is not shared with any other node within the executable graph-based model 100. Conversely, a shared attribute has data that is shared with one or more other nodes within the executable graph-based model 100. For example, if two nodes within the executable graph-based model 100 comprise a shared-data attribute with a value state shared by both nodes, updating the data (e.g., the value) of this shared attribute will be reflected across both nodes.

The node configuration 314 provides a high degree of configurations for the different elements of the generic node 302. The node configuration 314 optionally includes the one or more node configuration strategies 322 and/or the one or more node configuration extensions 324 which are complex data types. An example of a concrete node configuration strategy is an ID strategy, associated with the configuration of the unique ID 304a of the generic node 302, which creates message source IDs. A further example of a concrete node configuration strategy 322 is a versioning strategy, associated with the configuration of the version ID 304b of the generic node 302, which supports major and minor versioning (depending on the type of transactional change incurred by the generic node 302). The versioning strategy may be adapted to a native filing system of a user device hosting the overlay system 202 or a third-party data storage (for example, Snowflake^{®}, or the like) associated with the overlay system 202. All attribute configurations may be examples of node configuration extensions 324.

FIG. 3B is a block diagram 300B that illustrates a standard structure of a run-time node 336 within the executable graph-based model 100, consistent with disclosed embodiments of the present disclosure. Referring to FIG. 3B, the run-time node 336 corresponds to the core structure of the executable graph-based model 100 and forms the foundational building block for all data and processing logic within the executable graph-based model 100. The run-time node 336 is shown to include a node template 338 and a node instance 340. The node instance 340 is generated according to the node template 338. The node template 338 forms a data structure for the node instance 340. The run-time node 336 is shown in FIG. 3B is a compositional structure that is generated and executed, at run-time as part of the executable graph-based model 100. In other words, the node template 338 is defined as ‘offline’ and the node instance 340 and the run-time node 336 may be run-time structures that may be dynamically generated during execution of the executable graph-based model 100.

The node template 338 comprises a predetermined node structure. Further, the node template 338 defines one or more rules that govern the generation of the node instance 340. The node instance 340 is an implementation of the node template 338. In other words, the node instance 340 is generated based on the predetermined node structure and the one or more rules of the node template 338. The node template 338 cannot be modified during the execution but may be modified during offline mode or at rest. During execution, only the node instance 340 of the run-time node 336 may be modified.

The node template 338 may include properties 342, inheritance IDs 344, and a set of attribute templates 346. The node template 338 may optionally include metadata 348 and node configuration 350. The properties 342 of the node template 338 include a unique identifier (ID) 342a, a version ID 342b, a namespace 342c, a name 342d, and optionally include one or more icons 342e and a set of labels 342f. The inheritance IDs 344 comprise an abstract flag 352, a leaf flag 354, and a root flag 356. The node configuration 350 optionally comprises one or more node configuration strategies 358 and/or one or more node configuration extensions 360. FIG. 3B further shows a plurality of predetermined node type templates 362. The plurality of predetermined node type templates 362 may include a vertex node type template 364, an edge node type template 366, and an overlay node type template 368. Further, the node instance 340 may include a unique ID 370, a version ID 372, a node type instance 374, and a set of attribute instances 376. The node instance 340 may optionally include metadata 378. FIG. 3B further shows a plurality of predetermined node type instances 380. The plurality of predetermined node type instances 380 include a vertex node type instance 382, an edge node type instance 384, and an overlay node type instance 386.

The unique ID 342a is unique for each node template within the executable graph-based model 100. Similarly, the unique ID 370 is unique for each node instance within the executable graph-based model 100. The unique ID 342aand the unique ID 370 may be used to register, manage, and reference the node template 338 and the node instance 340, respectively, within the overlay system 202. The version ID 342b of the node template 338 represents a version of the node template 338. The version ID 342b gets incremented when the node template 338 undergoes a transactional change. Similarly, the version ID 372 of the node instance 340 represents a version of the node instance 340. The version ID 372 gets incremented when the node instance 340 undergoes a transactional change. The namespace 342c of the node template 338, along with the name 342d of the node template 338, is used to organize node templates within the executable graph-based model 100. That is, the node template 338 is assigned a unique name 342d within the namespace 342c such that the name 342d of the node template 338 need not be unique within the entire executable graph-based model 100, only within the context of the namespace 342c to which the node template 338 is assigned. The node template 338 optionally comprises one or more icons 342e which may be used to provide a visual representation of the node template 338. The one or more icons 342ecan include icons at different resolutions and display contexts such that the visualization of the node is adapted to different display contexts and settings. The node template 338 also optionally comprises the set of labels 342f which may be used to override the name 342d when the node template 338 is rendered or visualized.

The node template 338 supports the software development feature of multiple inheritance by maintaining references (not shown) to zero or more other node templates, which then act as the base of the node template 338. This allows the behavior and functionality of a node template to be extended or derived from one or more other node templates within an executable graph-based model. The node instance 340 likewise supports multiple inheritance because it is an instance representation of the node template 338. The multiple inheritance structure of the node instance 340 is, however, limited to the corresponding instance realization of the multiple inheritance structure defined by the node template 338, i.e., one node instance 340 is created and managed for each node template 338 defined in the inheritance hierarchy for a node instance of a node template.

The inheritance IDs 344 of the node template 338 provide an indication of the inheritance-based information, which is applicable, or can be applicable, to the node template 338. The node template 338 supports the concept of inheritance of data and processing logic associated with any other node template of the executable graph-based model 100 that is inherited by the node template 338. This allows the behavior and functionality of the node template 338 to be extended or derived from the inherited node template of the executable graph-based model 100. The inheritance IDs 344 of the node template 338 indicate the inheritance-based information, which may apply to the node template 338. The inheritance IDs 344 comprise a set of Boolean flags that identify the inheritance structure of the run-time node 336. The abstract flag 352 allows the node template 338 to support the construct of abstraction. When the abstract flag 352 takes a value ‘true’, the node template 338 is flagged as abstract that is to say that it cannot be instantiated or created within an executable graph-based model (e.g., the executable graph-based model 100). Thus, in an instance when the node template 338 has the abstract flag 352 set to ‘true’, the node template 338 may only form the foundation of other node templates that inherit therefrom. By default, the abstract flag 352 of the node template 338 is set to ‘false’. The leaf flag 354 is used to indicate whether any other node template may inherit from the node template 338. If the leaf flag 354 is set to ‘true’, then no other node template may inherit from the node template 338 (but unlike an abstract node, a node with the leaf flag 354 set may be instantiated and created within the executable graph-based model 100). The root flag 356 is used to indicate whether the node template 338 inherits from any other node template. If the root flag 356 is set to ‘true’, the node template 338 does not inherit from any other node. The node template 338 is flagged as leaf (e.g., the leaf flag 354 is set to ‘true’) and/or root (e.g., the root flag 356 is set to ‘true’), or neither (e.g., both the leaf flag 354 and the root flag 356 may be set to ‘false’). It will be apparent to a person skilled in the art that a node cannot be flagged as both abstract and leaf (e.g., the abstract flag 352 cannot be set to ‘true’ whilst the leaf flag 354 is set to ‘true’).

All elements within the executable graph-based model 100 may be defined as node templates or node instances. The functionality of the node template 338 and the node instance 340 may be realized due to the use of the node type template 362 and the node type instance 374. The node type template 362 of the node template 338 is used to extend the functionality of the node template 338 by defining the standard set of capabilities, including data and associated behavior. The vertex node type template 364 (also referred to as a data node type) may include a template of common data structures and functionality related to the ‘things’ modeled in the graph (e.g., the data). The vertex node type instance 382 may include the common data structures and functionality related to the ‘things’ modeled in the graph based on the vertex node type template 364. The edge node type template 366 may include a template of common data structures and functionality related to joining two or more nodes. A node instance having the edge node type instance 384 may connect two or more nodes and thus the edge node type instance 384 constructs associations and connections between nodes (for example objects or ‘things’) within the executable graph-based model 100. The edge node type instance 384 is not restricted to the number of nodes that can be associated or connected by a node having the edge node type instance 384. The data structures and functionality of the edge node type instance 384 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween. The plurality of predetermined node type templates 362 may further include the overlay node type template 368. The overlay node type template 368 is used to extend the functionality of a node template (e.g., the node template 338) to incorporate processing logic. Similarly, the overlay node type instance 386 is used to extend the functionality of a node instance (e.g., the node instance 340) to incorporate processing logic.

The set of attribute templates 346 corresponds to the data defined by the node template 338. For example, the set of attribute templates 346 may define the names and value types (e.g., integer, string, float, etc.) of one or more attributes but not the values of these attributes. The values of the set of attribute templates 346 may be defined by the set of attribute instances 376 of the node instance 340 through one or more values or instance values. For example, the node template 338 may define a string attribute ‘surname’ and the corresponding node instance 340 may assign the instance value ‘Bell-Richards’ to this string attribute. Each attribute instance of the set of attribute instances 376 may be associated with an attribute template of the set of attribute templates 346. The node template 338 may define one or more default values for the set of attribute templates 346. The default values correspond to the values that the attributes take if no value is assigned. The metadata 348 (e.g., data stored as a name, a value type, and a value triplet) may be associated with either the node template 338 or one or more of the set of attribute templates 346 of the node template 338. Similarly, the node instance 340 also optionally comprises the metadata 378 (e.g., data stored as a name, a value type, and a value triplet) which may be associated with either the node instance 340 or one or more of the set of attribute instances 376.

The node configuration 350 provides a high degree of configurability for the different elements of a node template and/or a node instance. An example of a concrete node configuration strategy is an ID strategy, associated with the configuration of the unique ID 342a of the node template 338. A further example of a concrete node configuration strategy is a versioning strategy, associated with the configuration of the version ID 342b of the node template 338 which supports major and minor versioning (depending on the type of transactional change incurred). The versioning strategy may be adapted to a native filing system of a user device hosting the overlay system 202 or a third-party data storage (for example, Snowflake^{®}, or the like) associated with the overlay system 202.

It will be apparent to a person skilled in the art that each run-time node of the executable graph-based model 100 has a standard structure that is similar to the run-time node 336 of FIG. 3B.

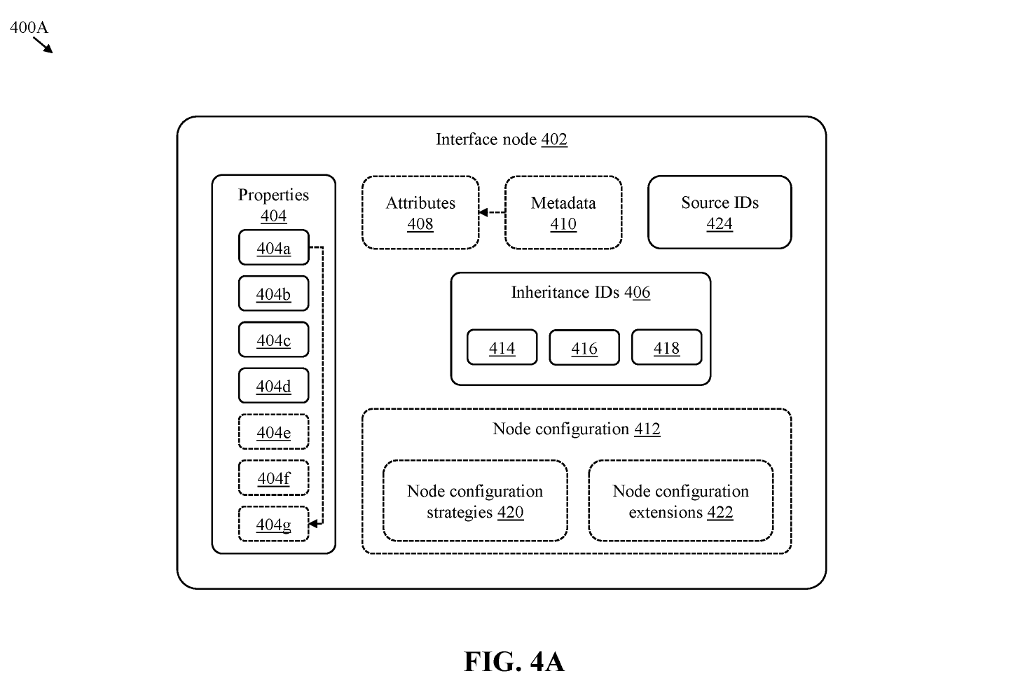

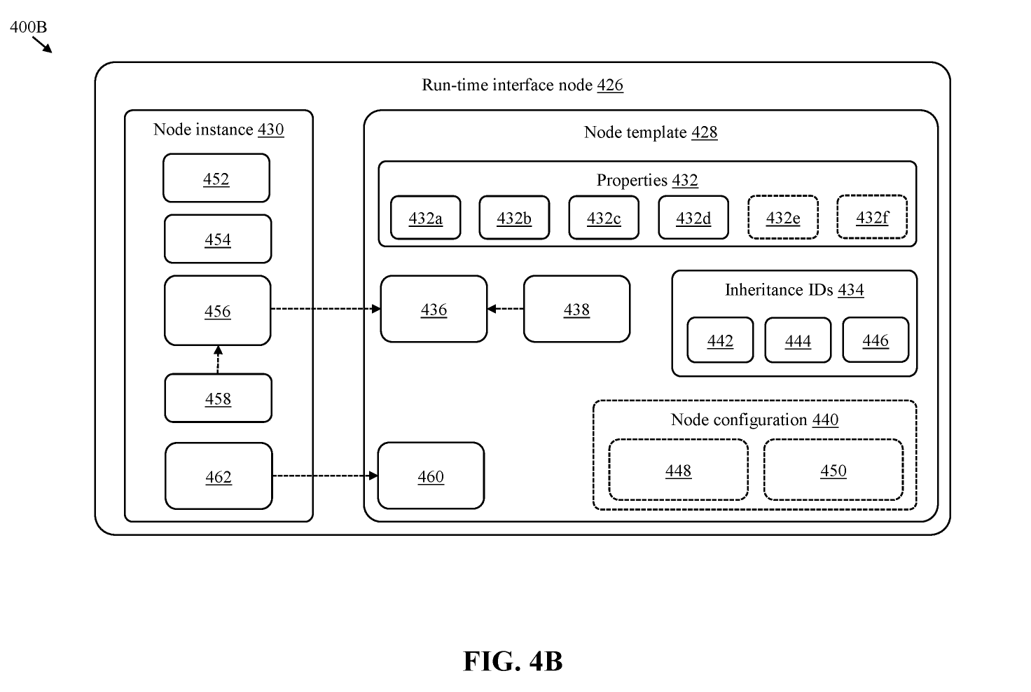

FIG. 4A is a block diagram 400A that illustrates a standard structure of an interface node 402 within the executable graph-based model 100, consistent with disclosed embodiments of the present disclosure. Referring to FIG. 4A, the interface node 402 corresponds to the core structure of the executable graph-based model 100 and forms the foundational building block for various data and processing logics within the executable graph-based model 100. The interface node 402 includes properties 404, inheritance IDs 406, attributes 408, metadata 410, and a node configuration 412.

The properties 404 include a unique ID 404a, a version ID 404b, a namespace 404c, a name 404d, one or more icons 404e, one or more labels 404f, and one or more alternative IDs 404g. The properties 404 of the interface node 402 are the same as the properties 304 of the generic node 302. In other words, the unique ID 404a, the version ID 404b, the namespace 404c, the name 404d, the one or more icons 404e, the one or more labels 404f, and the one or more alternative IDs 404g are same as the unique ID 304a, the version ID 304b, the namespace 304c, the name 304d, the one or more icons 304e, the one or more labels 304f, and the one or more alternative IDs 304g, respectively, of the generic node 302.

The inheritance IDs 406 of the interface node 402 include an abstract flag 414, a leaf flag 416, and a root flag 418. The inheritance IDs 406 of the interface node 402 is same as the inheritance IDs 306 of the generic node 302. In other words, the abstract flag 414, the leaf flag 416, and the root flag 418 are same as the abstract flag 316, the leaf flag 318, and the root flag 320, respectively, of the generic node 302. The attributes 408 has a description that is same as the description of the attributes 310. In addition, the metadata has a description that is same as the description of the metadata 312.

The node configuration 412 of the interface node 402 includes node configuration strategies 420 and node configuration extensions 422. The node configuration 412 is same as the node configuration 314 of the generic node 302. In other words, the node configuration strategies 420 and the node configuration extensions 422 of the interface node 402 are same as the node configuration strategies 322 and the node configuration extensions 324, respectively, of the generic node 302.

The interface node 402 may not have a node-type. The interface node 402 may be associated with a first plurality of active nodes of the plurality of active nodes. The first plurality of active nodes may be generic nodes. The first plurality of active nodes may have any node-types as described in conjunction with FIG. 3A. The interface node 402 may define a reusable structure for the first plurality of active nodes. Moreover, the first plurality of active nodes associated with the interface node 402 may act as source nodes for the interface node 402. That is to say that, the interface node 402 may be associated with a plurality of source nodes. As shown, the interface node 402 may further include source IDs 424 of the plurality of source nodes. In other words, the interface node 402 may include the source IDs 424 which may include IDs of each of the first plurality of active nodes. Notably, based on the first plurality of active nodes being generic nodes, the interface node 402 is a generic node.

The inclusion of the source IDs 424 in the standard structure of the interface node 402 enables the interface node 402 to be associated with the first plurality of active nodes having unique IDs that match the source IDs 424. Such an association allows the first plurality of active nodes to leverage the standard structure and various features of the interface node 402. Hence, the first plurality of active nodes may also leverage various functionalities (for example, data and processing logic) associated with the interface node 402. In other words, the first plurality of active nodes may also leverage data as well as overlay nodes associated with the run-time interface node 426.

FIG. 4B is a block diagram 400B that illustrates a standard structure of a run-time interface node 426 within the executable graph-based model 100, consistent with disclosed embodiments of the present disclosure. Referring to FIG. 4B, the run-time interface node 426 corresponds to the core structure of the executable graph-based model 100 and forms the foundational building block for all data and processing logic within the executable graph-based model 100. The run-time interface node 426 is shown to include a node template 428 and a node instance 430. The node template 428 of the run-time interface node 426 may correspond to an interface node template whereas the node instance 430 of the run-time interface node 426 may correspond to an interface node instance. The node instance 430 is generated according to the node template 428. The node template 428 forms a data structure for the node instance 430. Notably, the node template 428 corresponds to a predefined interface node structure. The node template 428 includes a reference (for example, a pointer, an identifier, or the like) to node template of each run-time node associated with the run-time interface node 426. Similarly, the node instance 430 may include a reference (for example, a pointer, an identifier, or the like) to node template of each run-time node associated with the run-time interface node 426. The run-time interface node 426 shown in FIG. 4B is a compositional structure that is generated and executed, at run-time as part of the executable graph-based model 100. In other words, the node template 428 is defined as ‘offline’ and the node instance 430 and the run-time interface node 426 may be run-time structures that may be dynamically generated during execution of the executable graph-based model 100.

The node template 428 may have a description similar to the node template 338 described in conjunction with FIG. 3B. Similarly, the node instance 430 may have a description similar to the node instance 340 described in conjunction with FIG. 3B.

The node template 428 may include properties 432, inheritance IDs 434, and a set of attribute templates 436. The node template 428 may optionally include metadata 438 and node configuration 440. The properties 432 of the node template 428 include a unique identifier (ID) 432a, a version ID 432b, a namespace 432c, a name 432d, and optionally include one or more icons 432e and a set of labels 432f. The inheritance IDs 434 comprise an abstract flag 442, a leaf flag 444, and a root flag 446. The node configuration 440 optionally comprises one or more node configuration strategies 448 and/or one or more node configuration extensions 450. Further, the node instance 430 may include a unique ID 452, a version ID 454, and a set of attribute instances 456. The node instance 430 may optionally include metadata 458.

The properties 432 of the node template 428 have a description that is similar to the description of the properties 342 described in conjunction with FIG. 3B. In other words, the unique identifier (ID) 432a, the version ID 432b, the namespace 432c, the name 432d, the icons 432e, and the set of labels 432f have descriptions that may be similar to descriptions of the unique identifier (ID) 342a, the version ID 342b, the namespace 342c, the name 342d, the icons 342e, and the set of labels 342f, respectively, shown in FIG. 3B.

The inheritance IDs 434 of the node template 428 may have a description that is similar to the inheritance IDs 344 of the node template 338. In other words, the abstract flag 442, the leaf flag 444, and the root flag 446 may have descriptions that may be similar to the abstract flag 352, the leaf flag 354, and the root flag 356, respectively, shown in FIG. 3B.

The set of attribute templates 436 has a description that is similar to the description of the set of attribute templates 346 described in conjunction with FIG. 3B. The metadata 438 has a description that is similar to the metadata 348 depicted in FIG. 3B. Similarly, the set of attribute instances 456 has a description that is similar to the set of attribute instances 376 of FIG. 3B and the metadata 458 have a description that is similar to the metadata 378 of FIG. 3B.

The node configuration 440 has a description that may be similar to the node configuration 350 of FIG. 3B. In other words, descriptions of the node configuration strategies 448 and the node configuration extensions 450 may be similar to the descriptions of the node configuration strategies 358 and the node configuration extensions 360, respectively, of FIG. 3B.

The unique ID 452 has a description that is similar to the description of the unique ID 370. The version ID 454 has a description that is similar to the description of the version ID 372. The set of attribute instances 456 has a description that is similar to the description of the set of attribute instances 376.

The run-time interface node 426 may not have a node-type. The run-time interface node 426 may be associated with a second plurality of active nodes of the plurality of active nodes. The second plurality of active nodes may be run-time nodes. The second plurality of active nodes may have any node-types as described in conjunction with FIG. 3B. The run-time interface node 426 may define a reusable structure for the second plurality of active nodes. Moreover, the second plurality of active nodes associated with the run-time interface node 426 may act as source nodes for the run-time interface node 426. That is to say that, the run-time interface node 426 may be associated with a plurality of source nodes. As shown, the node template 428 may further include a source IDs template 460 that may define a template for storing source IDs of the plurality of sources. The node instance 430 may further include a source IDs instance 462 that may include values of the plurality of source IDs. In other words, the run-time interface node 426 may include source IDs that may include IDs of each of the second plurality of active nodes. Based on the second plurality of active nodes being the run-time active nodes, the run-time interface node 426 is a run-time interface node.

The inclusion of the source IDs template 460 and the source IDs instance 462 in the standard structure of the run-time interface node 426 enables the run-time interface node 426 to be associated with the first plurality of run-time active nodes having unique IDs of corresponding node templates and corresponding node instances that match the source IDs template 460 and the source IDs instance 462, respectively. Such association allows the first plurality of run-time active nodes to leverage the standard structure and various features of the run-time interface node 426. Hence, the first plurality of run-time active nodes may also leverage various functionalities (for example, data and processing logic) associated with the run-time interface node 426. In other words, the first plurality of run-time active nodes may also leverage data as well as run-time overlay nodes associated with the run-time interface node 426.

Notably, a generic node (for example, the generic node 302), a run-time node (for example, the run-time node 336), an interface node (for example, the interface node 402), and a run-time interface node (for example, the run-time interface node 426) when associated with an overlay node may be referred to as an executable generic node, an executable run-time node, an executable interface node, and an executable run-time interface node, respectively. An overlay associated with a node (for example, a generic node, a run-time node, an interface node, or a run-time interface node) may extend functionality thereof. An overlay node associated with a generic node may be a generic overlay node i.e., having a node structure as described in conjunction with FIG. 3A. An overlay node associated with a run-time node may be a run-time overlay node i.e., having a node structure as described in conjunction with FIG. 3B.

It should be appreciated that the references to ‘first interface node,’ ‘second interface node,’ or other similar terms in the claims are not intended to refer to specific nodes but are used for distinguishing elements. These nodes may correspond to any of the interface nodes described in the specification, including, but not limited to, the interface nodes 402 and 426, or any other applicable interface node discussed herein.

It should be appreciated that the references to ‘first plurality of active nodes,’ ‘second plurality of active nodes,’ or other similar terms in the claims are not intended to refer to specific active nodes but are used for distinguishing elements. These active nodes may correspond to any of the active nodes described in the specification.

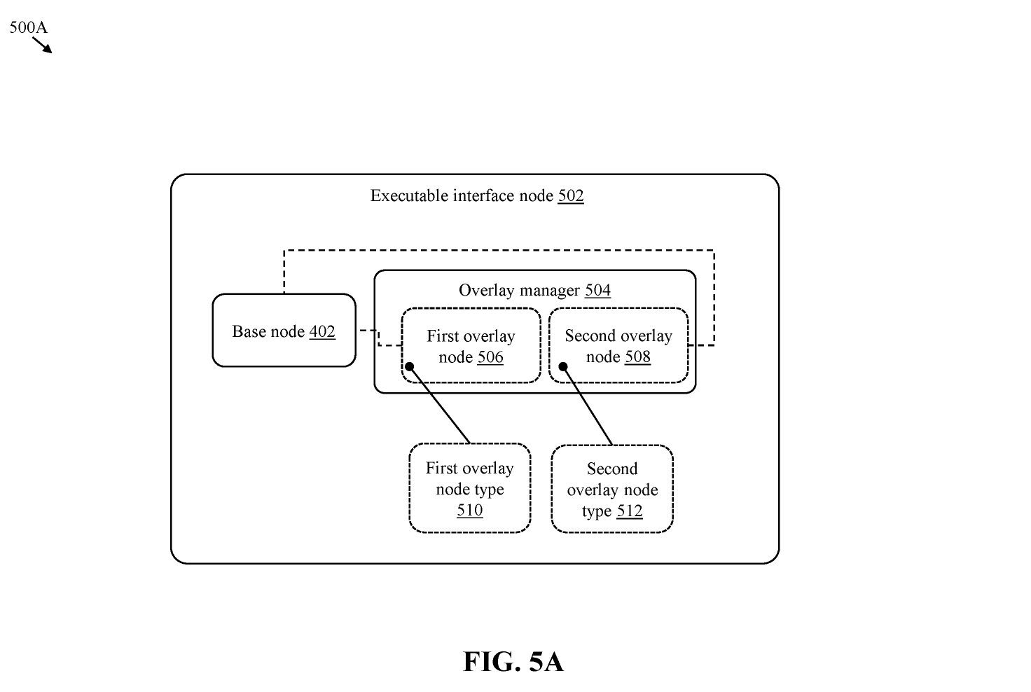

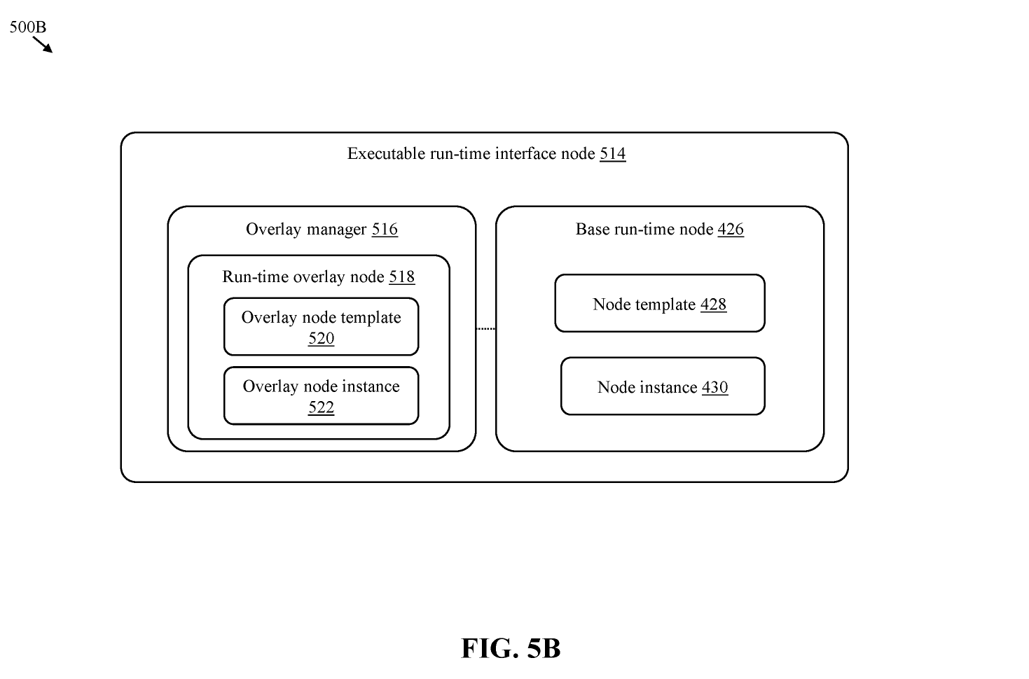

FIG. 5A is a block diagram 500A that illustrates an executable interface node 502 within the executable graph-based model 100, consistent with disclosed embodiments of the present disclosure. Referring to FIG. 5A, the executable interface node 502 is shown to include a base node (e.g., the interface node 402) and an overlay manager 504. For the sake of ongoing discussion, the base node corresponds to the interface node 402, and is hereinafter referred to as the “base node 402”. The base node 402 when extended by way of one or more overlay nodes becomes the executable interface node 502.

The executable interface node 502 provides processing functionality (e.g., processing logic) to the base node 402 via one or more associated overlay nodes (for example, the first and second overlay nodes). Beneficially, the data and processing capability of the base node 402 may be dynamically and significantly extended using the concept of an executable node (for example, the executable interface node 502). As shown, the first overlay node has a first overlay node-type 510, and the second overlay node has a second overlay node-type 512. Examples of overlay node-type include, but are not limited to, a subscriber overlay node, a publisher overlay node-type, and an encryption overlay node-type.

A node with the subscriber overlay node-type is a subscriber overlay node that is indicative of an operation of receiving an input from an associated node. The subscriber overlay node also includes processing logic to receive the input. A node with the publisher overlay node-type is a publisher overlay node that is indicative of an operation of publishing an output of an associated node. The publisher overlay node also includes processing logic to publish the output. A node with the encryption overlay node-type is an encryption overlay node that is indicative of an encryption technique using which an associated node is to be secured. The encryption overlay node also includes processing logic to secure a corresponding node. Examples of the encryption technique include a symmetric encryption algorithm, an asymmetric encryption algorithm, a combination of these, or any other encryption technique.

Although, the executable interface node 502 is assumed to include the first and second overlay nodes and, in other embodiments, the executable interface node 502 may include any number of overlay nodes, without deviating from the scope of the present disclosure.

The executable interface node 502 extends the base node 402 (or is a subtype of the base node 402) such that all the functionality and properties of the base node 402 are accessible to the executable interface node 502. The executable interface node 502 also dynamically extends the functionality of the base node 402 by associating the overlay nodes maintained by the overlay manager 504 with the base node 402. The executable interface node 502 may thus be considered a combination of the base node 402 and the first and second overlay nodes. The executable interface node 502 may be alternatively referred to as a node with overlay(s). Therefore, the executable interface node 502 acts as a decorator of the base node 402 adding the functionality of the overlay manager 504 to the base node 402.

It will be apparent to a person skilled in the art that the base node 402 may correspond to any suitable interface node within the executable graph-based model 100. Alternatively, the base node 402 may be an executable interface node such that the functionality of the (executable) base node 402 is dynamically extended. In this way, complex and powerful processing functionality can be dynamically generated by associating and extending overlay nodes.

Extending the functionality of a base node through one or more overlay nodes is at the heart of the overlay system 202. As illustrated in FIG. 2, the data (e.g., a vertex node as represented by the base node 402 in FIG. 5A) and the functionality that acts upon that data (e.g., an overlay node) can be separated and independently maintained offline, but at run-time, an association between the data node and the overlay node is determined and an executable interface node is generated (e.g., the executable interface node 502 shown in FIG. 5A).

It will be apparent to a person skilled in the art that functionalities of the first and second overlay nodes may be performed by a single overlay node that includes processing logic associated with both the first and second overlay nodes.

It will be apparent to a person skilled in the art that the list of overlay types is not exhaustive and the number of different overlay types that can be realized is not limited. Because an overlay node is itself a node, all functionality of a node described in relation to the base node 402 is thus applicable to an overlay node. For example, an overlay node includes a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node-type of the node to which the overlay node is applied.

An overlay node, such as the first overlay node 506 or the second overlay node 508, is not bound to a single executable node or a single executable graph-based model (unlike nodes that have non-overlay node-types). This allows overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays. Also, a single overlay node may be associated with multiple executable nodes. Thus, the overlay node and functionality thereof may be shared among the multiple executable nodes.

The overlay manager 504 of the executable interface node 502 is responsible for executing all overlays registered therewith. The overlay manager 504 also coordinates the execution of all associated overlay nodes. As shown in FIG. 5A, the executable interface node 502 associates the base node 402 with two overlay nodes that is the first overlay node 506 and the second overlay node 508. Thus, the overlay manager 504 employs a strategy to manage the potentially cascading execution flow. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies are defined and registered with the overlay manager 504 and are associated with an overlay via a node configuration extension for the overlay. Additionally, the overlay manager 504 may be configured to provide a set of attributes associated with the executable interface node 502 to the first overlay node 506 and/or the second overlay node 508. The first overlay node 506 and/or the second overlay node 508 may apply/execute corresponding processing logic on the set of attributes associated with the executable interface node 502.

It will be apparent to a person skilled in the art that a generic node may be associated with one or more overlay nodes as described in conjunction with FIG. 5A. Further, an overlay manager of the generic node may have a description similar to the description of the overlay manager 504.

FIG. 5B is a block diagram 500B that illustrates an executable run-time interface node 514 within the executable graph-based model 100, consistent with disclosed embodiments of the present disclosure. Referring to FIG. 5B, the executable run-time interface node 514 is shown to include the run-time interface node 426 (hereinafter referred to as ‘the base run-time node 426’) and an overlay manager 516. The overlay manager 516 may include a run-time overlay node 518. The executable run-time interface node 514 provides processing functionality (e.g., processing logic) to the base run-time node 426 via one or more associated overlay nodes (for example, the run-time overlay node 518). Beneficially, the data and processing capability of the base run-time node 426 may be dynamically and significantly extended using the concept of an executable run-time node (for example, the executable run-time interface node 514).

Although, the executable run-time interface node 514 is shown to include a single run-time overlay node 518, in other embodiments, the executable run-time interface node 514 may include any number of run-time overlay nodes. The run-time overlay node 518 may include an overlay node template 520 and an overlay node instance 522. The overlay node template 520 and the overlay node instance 522 may, collectively, constitute the run-time overlay node 518.

The executable run-time interface node 514 extends the base run-time node 426 (or is a subtype of the base run-time node 426) such that all the functionality and properties of the base run-time node 426 may be accessible to the executable run-time interface node 514. The executable run-time interface node 514 also dynamically extends the functionality of the base run-time node 426 by associating the run-time overlay nodes maintained by the overlay manager 516 with the base run-time node 426. The executable run-time interface node 514 may thus be considered a composition of the base run-time node 426 and the run-time overlay node 518. The executable run-time interface node 514 may be alternatively referred to as a run-time interface node with overlay(s). Therefore, the executable run-time interface node 514 acts as a decorator of the base run-time node 426 adding the functionality of the overlay manager 516 to the base run-time node 426.

It will be apparent to a person skilled in the art that the base run-time node 426 refers to any suitable run-time interface node within the executable graph-based model 100. Alternatively, the base run-time node 426 may itself be an executable node such that the functionality of the (executable) base run-time node 426 is dynamically extended. In this way, complex and powerful processing functionality can be dynamically generated by associating and extending overlay nodes.

The overlay manager 516 registers and maintains one or more run-time overlay nodes (such as the run-time overlay node 518) associated with the base run-time node 426. The overlay manager 516 may register and maintain the one or more run-time overlay nodes using one or more overlay node templates and one or more overlay node instances. For example, the overlay manager 516 may register the run-time overlay node 518 using the overlay node template 520 and the overlay node instance. The assignment of the run-time overlay node 518 to the base run-time node 426 (via the overlay manager 516) endows the base run-time node 426 with processing logic and executable functionality defined within the run-time overlay node 518. In other words, the run-time overlay node 518 may interact at run-time, with the node template 428 and/or the node instance 430 of the base run-time node 426. In an example, the node template 428 and the node instance 430 may be not executable nodes. That is, neither the node template 428 nor the node instance 430 comprises an overlay manager with one or more run-time overlay nodes. In another example, the node template 428 and/or the node instance 430 may be executable nodes thereby extending the functionality, complexity, and configurability of executable run-time nodes.

Extending the functionality of a base run-time node through one or more run-time overlay nodes is at the heart of the overlay system 202. As illustrated in FIG. 2, the data (e.g., a vertex node as represented by the base run-time node 426 in FIG. 5B) and the functionality that acts upon that data (e.g., an overlay node) can be separated and independently maintained offline, but at run-time, an association between the data node and the run-time overlay node is determined and an executable run-time node is generated (e.g., the executable run-time interface node 514).

Each run-time overlay node comprises an overlay node template and an overlay node instance. The overlay node template is a node template with the overlay node type template. Similarly, the overlay node instance is a node instance with the overlay node type instance. The overlay node instance is an implementation of the overlay node template. The overlay node template comprises one or more generic rules that may be implemented by the processing logic of the overlay node instance. For example, a rule may be defined in an overlay node template specifying that hashing algorithm is to be used and an overlay instance associated with the overlay template provides a specific implementation of a hashing algorithm (e.g., Message-Digest Algorithm 5 (MD5), Secure Hash Algorithm-1 (SHA-1), SHA-2, etc.).

A run-time overlay node, such as the run-time overlay node 518, is a node having an overlay node type (alternatively referred to as an overlay type) assigned to its node type. Examples of overlay node types include an encryption overlay node type, an obfuscation overlay node type, an audit overlay node type, an analytics overlay node type, a handler overlay node type, a publisher overlay node type, or the like. It will be apparent to a person skilled in the art that the list of overlay types is not exhaustive and the number of different overlay types that can be realized is not limited.

Because an overlay node is itself a node, all functionality of a node described in relation to the base run-time node 426 is thus applicable to an overlay node. For example, an overlay node may include a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay).

A run-time overlay node, such as the run-time overlay node 518, is not bound to a single executable node or a single executable graph-based model (unlike nodes that have non-overlay node types). This allows run-time overlay nodes to be centrally managed and reused across multiple instances of executable graph-based models. Notably, a node (for example, a base node, an interface node, an executable node, and an overlay node) may be extended by way of overlays. Further, each overlay node may be extended to have one or more overlays. Such overlays may be termed chaining overlays.

Unlike non-run-time overlay nodes, a run-time overlay node may include processing logic (not shown in FIG. 5B) which determines the functionality of the run-time overlay node. The processing logic of a run-time overlay node may include a block of executable code, or instructions, which carries out one or more operations associated with the facilitation of indexing within the executable graph-based model 100. The block of executable code is pre-compiled code, code that requires interpretation at run-time, or a combination of both. Different run-time overlay nodes provide different processing logic to realize different functionality. The overlay manager 516 of the executable run-time interface node 514 is responsible for executing all overlays registered therewith. The overlay manager 516 also coordinates the execution of all associated overlay nodes. As shown in FIG. 5B, the executable run-time interface node 514 associates the base run-time node 426 with the run-time overlay node 518.

In some embodiments, the overlay manager 516 employs a strategy to manage potentially cascading execution flow of overlays such that one overlay may be associated with one or more other overlays. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies may be defined and registered with the overlay manager 516 and may be associated with an overlay via a node configuration extension for the overlay.

It will be apparent to a person skilled in the art that a run-time node may be associated with one or more run-time overlay nodes as described in conjunction with FIG. 5B. Further, an overlay manager of the run-time node may have a description similar to the description of the overlay manager 516.

Throughout the description, an executable node (for example, an executable generic node, an executable run-time node, the executable interface node 502, and the executable run-time interface node 514) is represented by way of two concentric circles. In other words, the executable node is represented by way of an inner circle encircled by an outer circle, where the incircle represents a base node and the outer circle represents an overlay node associated with the base node.

It will be apparent to a person skilled in the art that an operation being performed by a node corresponds to an operation being performed by the processing circuitry while using the node.

Notably, an interface node (for example, the interface node 402, the run-time interface node 426, the executable interface node 502, and the executable run-time interface node 514) may be a stateful node or a stateless node. The interface node, being the stateful node, may be referred to as a stateful interface node. Based on the interface node being stateful, a state of the interface node persists in the storage element of the overlay system 202 upon unloading thereof. The state of the interface node may be used to re-generate/load the interface node in the executable graph-based model 100 based on a requirement thereof. Loading of the interface node is described in detail later in the description. Further, based on the interface node being the stateless node, the interface node may cease to exist in the storage element upon unloading thereof from the executable graph-based model 100. That is to say that, the interface node may be discarded from the overlay system 202 based on the unloading thereof. The interface node, being the stateless node, may be referred to as a stateless interface node.

Similarly, an overlay node (for example, the overlay nodes 506 and 508, and the run-time overlay node 518) may also be the stateful node or the stateless node. Based on the overlay node being the stateful node, a state of the overlay node persists in the storage element of the overlay system 202 upon unloading thereof. The state of the overlay node may be used to re-generate/load the overlay node in the executable graph-based model 100 based on a requirement thereof. The overlay node, being the stateful node, may be referred to as a stateful overlay node. Loading of the overlay node is described in detail later in the description. Further, based on the overlay node being the stateless node, the overlay node may cease to exist in the storage element upon the unloading. That is to say that, the overlay node may be discarded from the overlay system 202 based on the unloading thereof. The overlay node, being the stateless node, may be referred to as a stateless overlay node.

The overlay system 202 described in conjunction with FIGS. 1-5B is used to facilitate one or more operations associated with various nodes (for example, generic nodes, run-time nodes, interface nodes, and run-time interface nodes) in the executable graph-based model 100. Various concepts and features associated with the implementation of the interface nodes in conjunction with the active nodes are described below in detail.

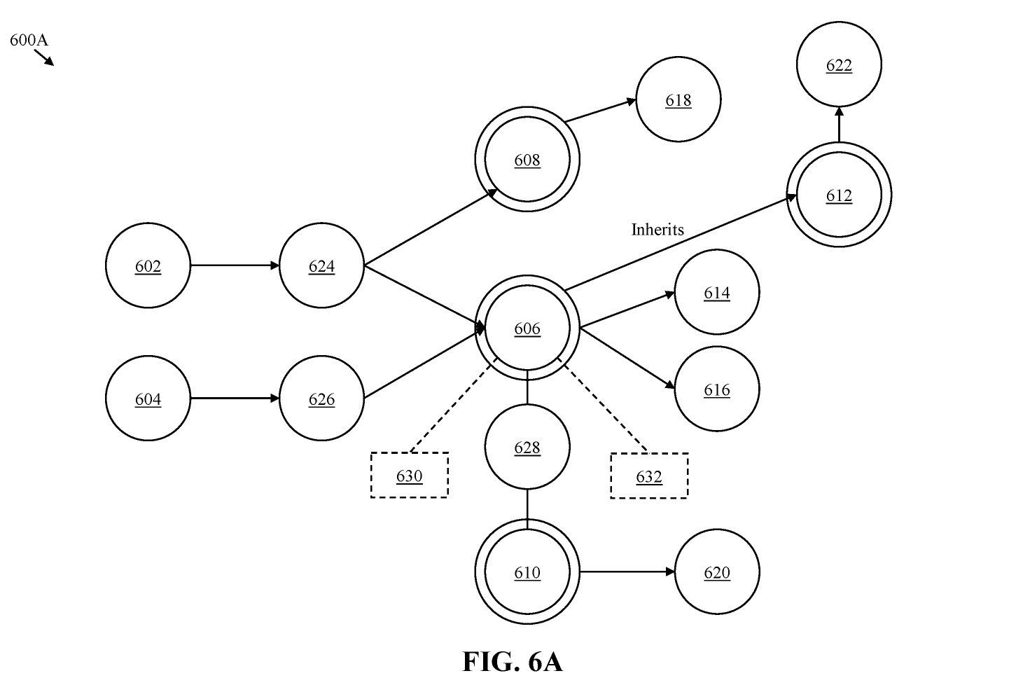

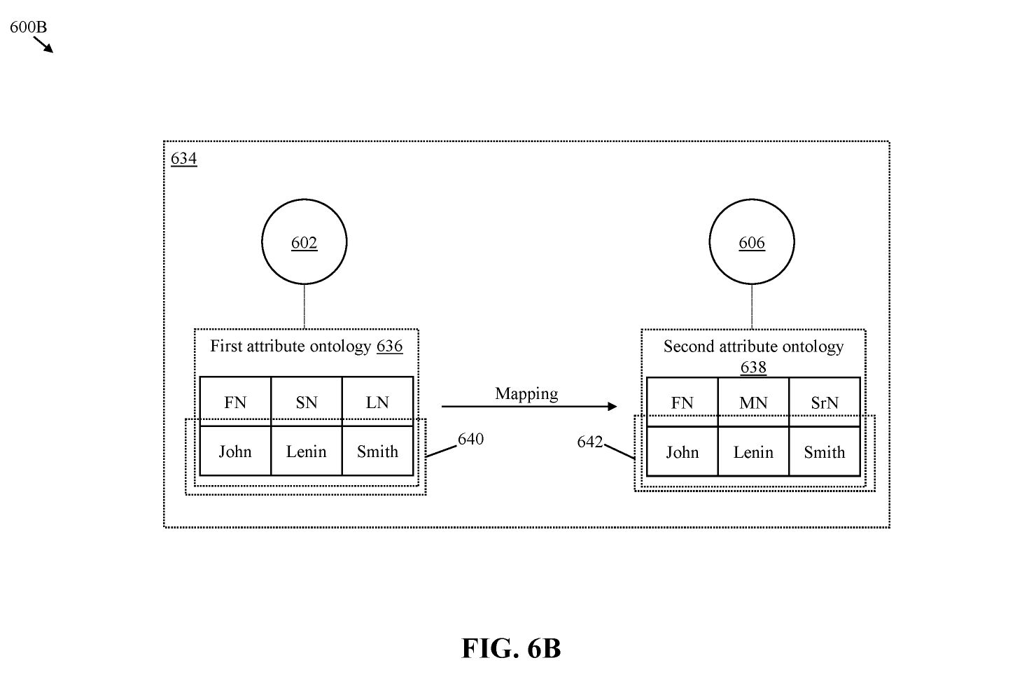

FIGS. 6A and 6B are schematic diagrams 600A and 600B that, collectively, illustrate implementation of a plurality of interface nodes in conjunction with the generic nodes, consistent with disclosed embodiments of the present disclosure. Referring to FIG. 6A, shown is a graph 600A, that is an implementation of the executable graph-based model 100, which includes a plurality of active nodes, a plurality of interface nodes, and a plurality of overlay nodes. An active node of the plurality of active nodes may be an edge node, a vertex node, a role node, or an overlay node. As shown, the plurality of active nodes include generic nodes 602 and 604, the plurality of interface nodes include interface nodes 606 – 612, and the plurality of overlay nodes 614 – 622. The executable graph-based model 100, implemented by way of the graph 600A, is further shown to include a plurality of interface utility nodes including interface utility nodes 624 – 628. An interface utility node of the plurality of interface utility nodes may act as a medium between an associated generic node and one or more interface nodes of the plurality of interface nodes.

Notably, the generic nodes 602 and 604 may be disparate nodes and hence, may not have any commonality therebetween. The generic nodes 602 and 604 are associated with the interface node 606. That is to say that, the interface node 606 defines a reusable structure for each of the generic nodes 602 and 604. In other words, data and/or processing logic associated with the interface node 606 may be used by each of the generic nodes 602 and 604 independently. Use of the data and/or processing logic of the interface node 606 by the generic node 602 may be independent of the use of the data and/or processing logic by the generic node 604. The generic nodes 602 and 604 may be associated with the interface node 606 by way of the interface utility nodes 624 and 626, respectively. An interface utility node may act as a medium between an active node and one or more interface nodes associated with the active node. The interface utility node enables the active node to communicate and use the data and/or processing logic of the one or more interface nodes. The interface utility node may be a part of a logical structure of the active node. As shown, the interface utility node 624 may act as a medium between the generic node 602 and the interface nodes 606 and 608 associated with the generic node 602. The interface utility node 624 may be a part of a logical structure of the generic node 602. Similarly, the interface utility node 626 may act as a medium between the generic node 604 and the interface node 606. The interface utility node 626 may be a part of a logical structure of the generic node 604.

The interface node 606 may be associated with one or more overlay nodes (for example, the overlay nodes 614 and 616) of the plurality of overlay nodes. Each overlay node (for example, the overlay nodes 614 and 616) associated with the interface node 606 may extend functionality thereof. Each overlay node may include corresponding processing logic that when executed by way of the interface node 606 may perform an associated transaction within the overlay system 202. Moreover, the interface node 606 may include an overlay manager 630 that may have a description similar to the overlay manager 504. The overlay manager 630 may be configured to manage the association of the interface node 606 with the overlay nodes 614 and 616. Additionally, the interface node 606 may include an interface manager 632 that may be configured to manage the association of the interface node 606 with the generic nodes 602 and 604. In other words, the interface manager 632 may be configured to facilitate and/or manage reusability of the interface node 606 by the generic nodes 602 and 604.

In some embodiments, the interface node 606 may be further associated with one or more other interface nodes (for example, the interface node 610). The interface utility node 628 may act as a medium between the interface nodes 606 and 610. The interface utility node 628 may be a part of a logical structure of the interface node 606. The interface node 610 may define a reusable structure for two or more interface nodes including the interface node 606 and/or two or more active nodes. In other words, data and/or processing logic associated with the interface node 610 may be reusable by interface nodes as well as active nodes associated therewith. As shown, the interface node 610 is extended by way of the overlay node 620. Therefore, the overlay node 620 may be used by the interface node 606 based on the association thereof with the interface node 610. Moreover, based on the association of the interface node 610 with the interface node 606, the generic nodes 602 and 604 may also access the data and/or processing logic associated with the overlay node 620.

In some embodiments, the interface node 606 may inherit one or more interface nodes (for example, the interface node 612) of the plurality of interface nodes. Based on such inheritance, the interface node 606 may access data and/or processing logic associated with the one or more interface nodes (for example, the interface node 612). As shown, the interface node 612 is extended by way of the overlay node 622. Therefore, based on the interface node 606 inheriting the interface node 612, the overlay node 622 may also be inherited and accessible by the interface node 606.

In some embodiments, an active node may have a plurality of interface nodes. As shown, the generic node 602 may be further associated with the interface node 608 by way of the interface utility node 624. Hence, the interface node 608 may define another reusable structure for the generic node 602. Therefore, data and/or processing logic associated with the interface node 608 may be accessible to the generic node 602. As shown, the interface node 608 is extended by way of the overlay node 618. Hence, based on the association of the generic node 602 with the interface node 608, the overlay node 618 may be accessible to the generic node 602.

In operation, the processing circuitry (for example, the controller module 206, the transaction module 208, or the like) may receive a stimulus (for example, the stimulus 230) associated with the overlay system 202. The stimulus may correspond to a transaction to be performed on each of the generic nodes 602 and 604. Based on the stimulus, the processing circuitry (for example, the controller module 206, the transaction module 208, or the like) may identify the generic nodes 602 and 604. The processing circuitry (for example, the controller module 206, the transaction module 208, or the like) may identify the generic nodes 602 and 604 based on a context of the stimulus.

Based on the identification of the generic nodes 602 and 604, the processing circuitry (for example, the controller module 206, the transaction module 208, or the like) may be configured to determine whether the generic nodes 602 and 604 are unloaded from the executable graph-based model 100. Based on the determination of the generic nodes 602 and 604 being unloaded from the executable graph-based model 100, the processing circuitry (for example, the memory management module 218, the storage management module 220, or the like) may be configured to load the generic nodes 602 and 604 in the executable graph-based model 100. Loading of a node is described in detail in conjunction with FIG. 8.

The processing circuitry (for example, the controller module 206, the transaction module 208, or the like) may be configured to determine that each of the generic nodes 602 and 604 may not be associated with an overlay node that may have processing logic that when executed performs one or more operations of a transaction associated with the stimulus. In other words, the processing circuitry (for example, the controller module 206, the transaction module 208, or the like) may be configured to determine that the generic nodes 602 and 604 may have an absence of an association with an overlay node having functionality that conforms with the transaction associated with the stimulus. Throughout the description, one or more operations associated with the stimulus are referred to as the transaction. Based on such a determination, the processing circuitry (for example, the controller module 206, the transaction module 208, or the like) may be configured to determine the interface node 606 associated with each of the identified generic nodes 602 and 604. The interface node 606 may be determined based on association thereof with the overlay node 614 having a functionality that conforms with the stimulus.

In some embodiments, prior to the identification of the interface node 606, the processing circuitry (for example, the controller module 206, the transaction module 208, or the like) may be configured to identify the overlay node 614 from overlay nodes (for example, the overlay nodes 614 and 616) associated with the interface node 606. The overlay node 614 may be identified based on processing logic or functionality thereof being in conformity with the stimulus. In other words, the overlay node 614 may be identified based on the processing logic thereof being in conformity with the transaction associated with the stimulus. That is to say that, the processing logic of the overlay node 614, when executed, may perform one or more operations associated with the stimulus. Subsequently, based on the identification of the overlay node 614, the interface node 606 may be identified.

In some embodiments, the overlay node 614 may be determined based on the determination of the interface node 606 being associated with the generic nodes 602 and 604 and defining a reusable structure for the generic nodes 602 and 604.

The processing circuitry (for example, the controller module 206, the transaction module 208, or the like) may be configured to determine whether the interface node 606 and/or the overlay node 614 is unloaded from the executable graph-based model 100. Based on the determination of the interface node 606 and/or the overlay node 614 being unloaded from the executable graph-based model 100, the processing circuitry (for example, the memory management module 218, the storage management module 220, or the like) may be configured to load the interface node 606 and/or the overlay node 614 in the executable graph-based model 100. Loading of a node is described in detail in conjunction with FIG. 8.

The processing circuitry (for example, the controller module 206, the transaction module 208, or the like) may be further configured to determine, from the plurality of interface utility nodes, the interface utility nodes 624 and 626 associated with the generic nodes 602 and 604, respectively. The processing circuitry (for example, the memory management module 218, the storage management module 220, or the like) may be further configured to load the interface utility nodes 624 and 626 as a logical part of the generic nodes 602 and 604, respectively.

Subsequently, the processing circuitry (for example, the controller module 206, the transaction module 208, or the like) may initiate execution of the transaction associated with the stimulus based on the generic nodes 602 and 604, the interface node 606, the overlay node 614, and the interface utility nodes 624 and 626. For executing the transaction, the processing circuitry (for example, the controller module 206, the transaction module 208, or the like) may use the interface manager 632 of the interface node 606 to acquire a first set of attribute values of each of the generic nodes 602 and 604. In addition, the processing circuitry (for example, the controller module 206, the transaction module 208, or the like) may use the interface manager 632 of the interface node 606 to determine a first attribute ontology associated with each of the generic nodes 602 and 604. The processing circuitry (for example, the controller module 206, the transaction module 208, or the like) may further use the interface manager 632 to map the first attribute ontology of each of the generic nodes 602 and 604 with a second attribute ontology of the interface node 606. An attribute ontology may refer to a set of constraints (for example, data organization constraints, nomenclature constraints, or the like) based on which attribute values of attributes associated with a node (for example, generic node, run-time node, interface node, run-time interface node, or the like) are organized and stored.

The processing circuitry (for example, the controller module 206, the transaction module 208, or the like) may be further configured to assign the first set of attribute values of each of the generic nodes 602 and 604 to a second set of attribute values of the interface node 606. Such an assignment of the first set of attribute values to the second set of attribute values may be performed based on the mapping of the first attribute ontology with the second attribute ontology. In addition, each attribute of the second set of attributes may have zero or more attribute values assigned thereto. For example, the first set of attributes of the generic node 602 may include a first attribute value for a first attribute and may not have an attribute value for a second attribute. In addition, the first set of attributes of the generic node 604 may include a second attribute value for the first attribute, a third attribute value for the second attribute, and a fourth attribute value for a third attribute. The second set of attributes of the interface node may include the first attribute, the second attribute, the third attribute, and a fourth attribute. Based on the mapping, the first attribute, of the second set of attributes, may have the first attribute value and the second attribute value assigned thereto. Similarly, the second attribute, of the second set of attributes, may have the third attribute value assigned thereto. The third attribute of the second set of attributes may have the fourth attribute value assigned thereto. The fourth attribute of the second set of attributes may not have any attribute value assigned thereto. Mapping of the first attribute ontology with the second attribute ontology is described in detail in conjunction with FIG. 6B.

Referring to FIG. 6B, shown is an exemplary mapping of the first attribute ontology of the generic node 602 with the second attribute ontology of the interface node 606.

A dotted box 634 illustrates an exemplary process of mapping of the first attribute ontology with the second attribute ontology performed by the interface manager 632. As shown, the generic node 602 is associated with the first attribute ontology (hereinafter referred to as the first attribute ontology 636), and the interface node 606 is associated with the second attribute ontology (hereinafter referred to as the second attribute ontology 638). Based on the first attribute ontology 636, the first set of attributes (shown within a dotted box 640) of the generic node 602 may include attributes ‘First name’ (hereinafter, depicted and referred to as FN), ‘Second name’ (hereinafter, depicted and referred to as SN), ‘last name’ (hereinafter, depicted and referred to as LN). The attributes FN, SN, and LN may be associated with attribute values ‘John’, ‘Lenin’, and ‘Smith’, respectively. Further, based on the second attribute ontology 638, the second set of attributes of the interface node 606 may include attributes FN, ‘Middle name’ (hereinafter, depicted and referred to as MN), ‘Surname’ (hereinafter, depicted and referred to as SrN).

The processing circuitry (for example, the controller module 206, the transaction module 208, or the like) may use the interface manager 632 to determine a set of similarities and a set of differences associated with the first attribute ontology 636 and the second attribute ontology 638. The set of similarities and the set of differences may be determined based on a comparison between the first attribute ontology 636 and the second attribute ontology 638. For example, the set of similarities may include the FN of the first attribute ontology 636 being same as the FN of the second attribute ontology 638. The set of differences may include (i) the SN of the first attribute ontology 636 is same as the MN of the second attribute ontology 638 and (ii) the LN of the first attribute ontology 636 is same as the SrN of the second attribute ontology 638. Therefore, the processing circuitry (for example, the controller module 206, the transaction module 208, or the like) may use the interface manager 632 to assign (as shown within a dotted box 642) the attribute values ‘John’, ‘Lenin’, and ‘Smith’ to the attributes FN, MN, and SrN, respectively, associated with the second set of attributes.

Now, referring back to FIG. 6A, the processing circuitry (for example, the controller module 206, the transaction module 208, or the like) may be further configured to execute the transaction associated with the stimulus based on the attribute values of the second set of attributes.

The processing circuitry (for example, the controller module 206, the transaction module 208, or the like) may use the overlay manager 630 to provide the attribute values assigned to the second set of attributes to the overlay node 614. The processing circuitry (for example, the controller module 206, the transaction module 208, or the like) may execute the transaction based on an execution/application of the processing logic of the overlay node 614 on the attribute values of the second set of attributes of the interface node 606. The processing circuitry (for example, the controller module 206, the transaction module 208, or the like) may generate, based on the execution of the processing logic of the overlay node 614 on the attribute values of the second set of attributes, an output including a second set of attribute values. The second set of attribute values may adhere to the second attribute ontology 638. Therefore, based on the mapping, the processing circuitry (for example, the controller module 206, the transaction module 208, or the like) may assign the second set of attribute values or a subset of the second set of attribute values to the first set of attributes of each of the generic nodes 602 and 604.

Referring again to FIG. 6B, based on execution of the processing logic of the overlay node 614 on the attribute values ‘John’, ‘Lenin’, and ‘Smith’ of the second set of attributes (shown within the dotted box 642) including the FN, the MN, and the SrN, respectively, the second set of attribute values (not shown) may be generated. In some embodiments, the processing circuitry (for example, the controller module 206, the transaction module 208, or the like) may assign an attribute value (for example, metadata, label, or the like) determined based on the FN of the second set of attributes to the FN of the first set of attributes. Similarly, the processing circuitry (for example, the controller module 206, the transaction module 208, or the like) may assign an attribute value determined based on the MN of the second set of attributes to the SN of the first set of attributes. Further, the processing circuitry (for example, the controller module 206, the transaction module 208, or the like) may assign an attribute value determined based on the SrN of the second set of attributes to the LN of the first set of attributes. Although FIG. 6B discussed the mapping of the first and second attribute ontologies with respect to the generic node 602 only, it will be apparent to a person skilled in the art that mapping of the first and second attribute ontologies for the generic node 604 may be performed in a similar manner.

Referring back to FIG. 6A, in some embodiments, the output of the transaction i.e., the second set of attributes may be stored in association with one of the generic nodes 602 and 604, and the interface node 606. In an instance, the interface node 606 may be the stateful node. Therefore, the interface node 606 may persist in the storage element upon being unloaded from the executable graph-based model 100. In such an instance, the output of the transaction may be stored in the storage element in association with the interface node 606. In another instance, the interface node may be the stateless node. Therefore, the interface node 606 may cease to exist in (i.e., discarded from) the storage element upon being unloaded from the executable graph-based model 100. In such an instance, the output of the transaction may be stored in the storage element in association with the generic nodes 602 and 604.

In some embodiments, the output of the transaction i.e., the second set of attributes may be stored in association with one of the generic nodes 602 and 604, the interface node 606, or the overlay node 614. In an instance, the interface node 606 as well as the overlay node 614 may be the stateless nodes. In such an instance, the output may be stored in the storage element in association with the generic nodes 602 and 604. In order to store the output in association with the generic nodes 602 and 604, the output may be cloned in association with the generic nodes 602 and 604 or merged with the first set of attributes of the generic nodes 602 and 604. Based on the output being cloned, the output may be stored separately from the first set of attribute values of the generic nodes 602 and 604. On the contrary, based on the output being merged, the second set of attribute values or a subset thereof may be merged with the first set of attribute values of the generic nodes 602 and 604.

In an instance, the interface node 606 may be the stateful node and the overlay node 614 may also be the stateful node. In such an instance, the output may be stored in the storage element in association with the overlay node 614. Alternatively, the output may be stored in the storage element in association with the interface node 606.

In an instance, the interface node 606 may be the stateful node and the overlay node 614 may be the stateless node. In such an instance, the output may be stored in the storage element in association with the interface node 606.

In an instance, the interface node 606 may be the stateless node and the overlay node 614 may be the stateful node. In such an instance, the output may be stored in the storage element in association with the generic nodes 602 and 604. In some embodiments, the output may be stored in association with any of the generic nodes 602 and 604, the interface node 606, or the overlay node 614, based on a user input received by the overlay system 202. In some embodiments, the output may be stored in association with any of the generic nodes 602 and 604, the interface node 606, or the overlay node 614, based on a relevance of the output with the generic nodes 602 and 604, the interface node 606, or the overlay node 614. In some embodiments, the output may be stored in association with any of the generic nodes 602 and 604, the interface node 606, or the overlay node 614, based on an operational requirement associated with the output.

Based on the generation of the output which indicates a completion of the execution of the transaction associated with the stimulus, the processing circuitry (for example, the memory management module 218 and the storage management module 220, or the like) may be configured to unload the generic nodes 602 and 604, the interface node 606, or the overlay node 614 from the executable graph-based model 100.

Notably, in an instance when the output i.e., the second set of attribute values may be required to be accessed, a node (for example, the generic node 602 and 604, the interface node 606, or the overlay node 614) in association with which the output may have been stored in the storage element may have to be loaded in the executable graph-based model 100. Loading of a node is described in detail in conjunction with FIG. 8.

In some embodiments, the processing circuitry (for example, the controller module 206, the transaction module 208, or the like) may be further configured to determine, based on the stimulus, the overlay node 616 associated with the interface node 606. The overlay node 616 may have processing logic that conforms with the transaction associated with the stimulus. In other words, the overlay node 616 may have a functionality that conforms with the stimulus. The processing circuitry (for example, the controller module 206, the transaction module 208, or the like) may be configured to execute the transaction associated with the stimulus further based on the overlay node 616. The processing circuitry (for example, the controller module 206, the transaction module 208, or the like) may be configured to execute the processing logic associated with the overlay node 616 on the first set of attribute values of each of the generic nodes 602 and 604.

In some embodiments, the processing circuitry (for example, the controller module 206, the transaction module 208, or the like) may be further configured to determine, based on the stimulus, the interface node 608 and the overlay node 618 associated with the interface node 608. The interface node 608 may be associated with the generic node 602 by way of the interface utility node 624. That is to say that, the interface utility node 624 may further act as a medium between the generic node 602 and the interface node 608. The interface node 608 may define a reusable structure for the generic node 602. The interface node 608 may further be associated with one or more other generic nodes (not shown). The overlay node 618 may extend a functionality of the interface node 608. Based on the association with the interface node 608, the generic node 602 may access the overlay node 618. The transaction associated with the stimulus may be executed further based on the interface node 608 and the overlay node 618. The processing circuitry (for example, the controller module 206, the transaction module 208, or the like) may be configured to execute the processing logic associated with the overlay node 618 on the first set of attribute values associated with the generic node 602.

In some embodiments, the processing circuitry (for example, the controller module 206, the transaction module 208, or the like) may be configured to determine, based on the stimulus, the interface node 610. The processing circuitry (for example, the controller module 206, the transaction module 208, or the like) may be further configured to determine, based on the stimulus, the overlay node 620 associated with the interface node 610. The overlay node 620 may extend a functionality of the interface node 610. The overlay node 620 may have processing logic that conforms with the transaction associated with the stimulus. In other words, the overlay node 620 may have a functionality that conforms with the stimulus. The processing circuitry (for example, the controller module 206, the transaction module 208, or the like) may be configured to execute the transaction associated with the stimulus further based on the interface node 610 and the overlay node 620. The processing circuitry (for example, the controller module 206, the transaction module 208, or the like) may be configured to execute the processing logic associated with the overlay node 620 on the first set of attribute values of each of the generic nodes 602 and 604.

In some embodiments, the processing circuitry (for example, the controller module 206, the transaction module 208, or the like) may be configured to identify the interface node 612 inherited by the interface node 606. The interface node 612 is extended by way of the overlay node 622. Based on the interface node 606 inheriting the interface node 612, the interface node 606 further inherits data and/or processing logic associated with the interface node 612. In other words, the interface node 606 may inherit the overlay node 622 associated with the interface node 612. Based on the identification of the interface node 612, the processing circuitry (for example, the controller module 206, the transaction module 208, or the like) may be further configured to determine the overlay node 622 associated with the interface node 612. Subsequently, the processing circuitry (for example, the controller module 206, the transaction module 208, or the like) may execute the transaction associated with the stimulus further based on the interface node 612 and the overlay node 622. This marks the completion of the transaction associated with the stimulus.

Notably, throughout the description of FIGS. 6A and 6B, the active nodes are assumed to be generic nodes. Therefore, based on the active nodes being the generic nodes, the interface nodes are considered to be generic interface nodes. Throughout the description, a generic interface node is assumed to be an interface node that is not a run-time interface node. That is to say that, unlike the run-time interface node, the generic interface node may not have a node template and a node instance.

It will be apparent to a person skilled in the art that, although not shown, the generic nodes 602 and 604 may be further associated with one or more overlay nodes extending functionality thereof.

Having discussed the implementation of the interface nodes in conjunction with the active nodes that may be generic nodes, the description now moves towards implementation of interface nodes in conjunction with the active nodes that may be run-time nodes. Based on the active nodes being the run-time nodes, the interface nodes associated with the run-time nodes may also be run-time interface nodes.

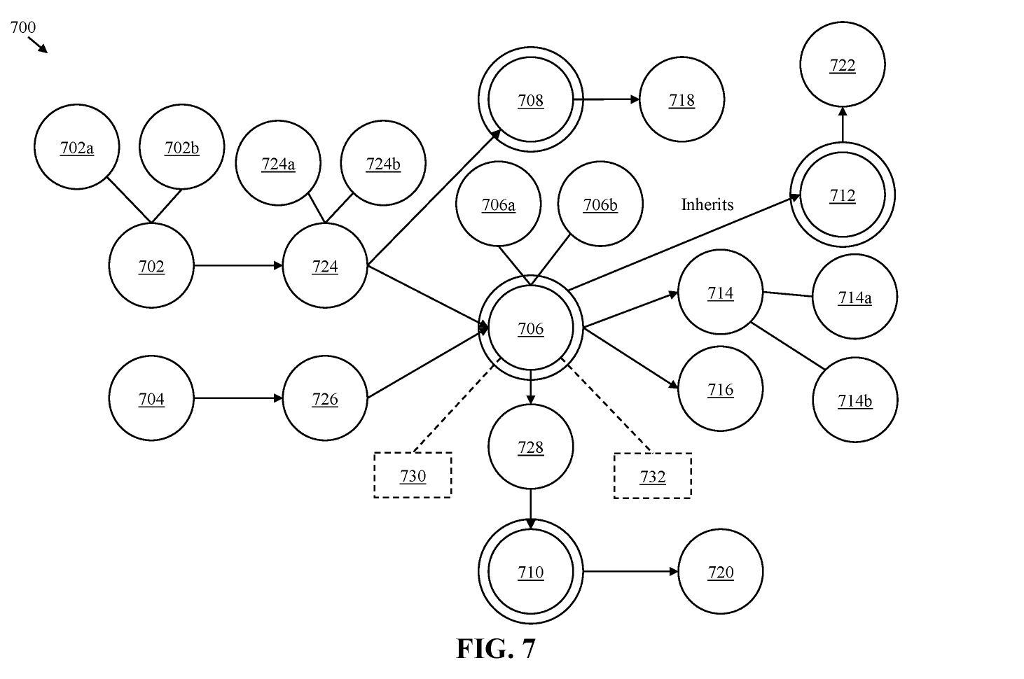

FIG. 7 is a graph 700 that illustrates implementation of a plurality of interface nodes in conjunction with the run-time nodes, consistent with disclosed embodiments of the present disclosure. Referring to FIG. 7, shown is the graph 700 that is an implementation of the executable graph-based model 100 which includes the plurality of active nodes, the plurality of run-time interface nodes, and the plurality of run-time overlay nodes. As shown, the plurality of active nodes include run-time nodes 702 and 704, the plurality of run-time interface nodes include run-time interface nodes 706 – 712, and the plurality of run-time overlay nodes 714 – 722. The executable graph-based model 100 implemented by way of the graph 700 is further shown to include a plurality of run-time interface utility nodes including run-time interface utility nodes 724 – 728. The plurality of run-time interface utility nodes may act as a medium between the plurality of run-time nodes and the plurality of run-time interface nodes. It is assumed that the run-time nodes 702 and 704 may be disparate nodes and hence, may not have any commonality therebetween.

For the sake of description of FIG. 7, based on the active nodes depicted in FIG. 7 being run-time nodes, various nodes (for example, the interface nodes, the interface utility nodes, and the overlay nodes) depicted in FIG. 7 are also run-time nodes. As discussed previously, in conjunction with FIG. 3B, a run-time node includes a node template and a node instance. The node template corresponds to a predefined node structure whereas the node instance corresponds to an implementation of the node template. As shown, the run-time node 702 includes a node template 702a and a node instance 702b. Although not shown, the run-time node 704 may similarly include a node template and a node instance. Further, the run-time interface utility node 724 may also include a node template 724a and a node instance 724b. Similarly, the run-time interface utility nodes 726 and 728 may also include corresponding node templates and node instances. Moreover, the run-time interface node 706 is also shown to include a node template 706a and a node instance 706b. Similarly, each of the run-time interface nodes 708, 710, and 712 may also include corresponding node template and node instance. Further, the run-time overlay node 714 is also shown to include a node template 714a and a node instance 714b. Similarly, each of the run-time overlay nodes 716, 718, 720, and 722 may also include a corresponding node template and a corresponding node instance.

The run-time nodes 702 and 704 are associated with the run-time interface node 706. That is to say that, the run-time interface node 706 defines a reusable structure for each of the run-time nodes 702 and 704. In other words, data and/or processing logic associated with the run-time interface node 706 may be used by each of the run-time nodes 702 and 704 independently. Use of the data and/or processing logic of the run-time interface node 706 by the run-time node 702 may be independent of use of the data and/or processing logic by the run-time node 704. The run-time nodes 702 and 704 may be associated with the run-time interface node 706 by way of the run-time interface utility nodes 724 and 726, respectively. As shown, the run-time interface utility node 724 may act as a medium between the run-time node 702 and the run-time interface nodes 706 and 708. The run-time interface utility node 724 may be a part of a logical structure of the run-time node 702. Similarly, the run-time interface utility node 726 may act as a medium between the run-time node 704 and the run-time interface node 706. The run-time interface utility node 726 may be a part of a logical structure of the run-time node 704.

The run-time interface node 706 may be associated with one or more run-time overlay nodes (for example, the run-time overlay nodes 714 and 716) of the plurality of run-time overlay nodes. Each run-time overlay node (for example, the run-time overlay nodes 714 and 716) associated with the run-time interface node 706 may extend functionality thereof. Each run-time overlay node may include corresponding processing logic that when executed by way of the run-time interface node 706 may perform an associated transaction within the overlay system 202. Moreover, the run-time interface node 706 may include an overlay manager 730 that may have a description similar to the overlay manager 516. The overlay manager 730 may be configured to manage the association of the run-time interface node 706 with the run-time overlay nodes 714 and 716. Additionally, the run-time interface node 706 may include an interface manager 732 that may be configured to manage the association of the run-time interface node 706 with the run-time nodes 702 and 704. In other words, the interface manager 732 may be configured to facilitate and/or manage reusability of the run-time interface node 706 by the run-time nodes 702 and 704.

Various concepts that are associated with the implementation of the interface nodes in conjunction with the generic nodes as discussed in conjunction with FIGS. 6A and 6B may also be applicable to the implementation of the run-time interface nodes in conjunction with the run-time nodes.

Additionally, loading of a run-time node (for example, a run-time node, a run-time interface node, a run-time interface utility node, a run-time overlay node, or the like) is performed based on loading of its node template and node instance. The description now moves toward discussion of various concepts associated with loading of nodes (for example, the generic nodes, the run-time nodes, the interface nodes, the run-time interface nodes, or the like) in the executable graph-based model 100.

FIG. 8 is a block diagram 800 that illustrates a composition of the executable interface node 502 that enables persistent storage of data and the processing logic associated therewith, consistent with disclosed embodiments of the present disclosure.

As described in conjunction with FIG. 5A, the executable interface node 502 includes the base node 402 and one or more overlay nodes (e.g., the first and second overlay nodes 506 and 508, respectively). For the brevity of the ongoing description, the persistent storage is explained for the executable interface node 502 including only the first overlay node 506. One or more operations performed for ensuring the persistence of the first overlay node 506 may be performed for the second overlay node 508 as well.

Referring to FIG. 8, the executable interface node 502 includes the base node 402 and the first overlay node 506. The executable interface node 502 has a corresponding first state 802 having a first ID 804. The base node 402 has a second state 806 having a second ID 808, and the first overlay node 506 has a third state 810 having a third ID 812. A manifest (for example, first through third manifests 814-818) is generated for each of the base node 402, the executable interface node 502, and the first overlay node 506. In an embodiment, the manifests may be generated by the storage management module 220. The first manifest 814 is associated with the executable interface node 502 and has a fourth ID 820 and an overlay ID 822. The second manifest 816 is associated with the base node 402 and has a fifth ID 824. The third manifest 818 is associated with the first overlay node 506 and has a sixth ID 826. Further, the manifests are stored at respective storage locations that may be centralized or distributed storage locations associated with the overlay system 202. The manifests may be stored by the storage management module 220.

The first state 802 of the executable interface node 502 includes data required to reconstruct the executable interface node 502 (e.g., attributes, properties, etc.). The first state 802 of the executable interface node 502 is persistently stored along with the first ID 804. The first manifest 814 is generated for the executable interface node 502 and has (i) the fourth ID 820 (which is the same as the first ID 804), (ii) the storage location of the first state 802 of the executable interface node 502, and (iii) the overlay ID 822 (which is the same as the sixth ID 826). Notably, the fourth ID 820 is the same as the first ID 804 and the fifth ID 824, hence, the first manifest 814 includes the ID of the state of the base node 402 and the executable interface node 502. Further, the overlay ID 822 is the same as the sixth ID 826 of the state of the first overlay node 506. Therefore, the first manifest 814 may be used to identify and retrieve the states of the base node 402, the executable interface node 502, and the first overlay node 506. Subsequently, the retrieved states may be used to reconstruct the executable interface node 502 and the first overlay node 506. In an instance, the executable interface node 502 may be further extended to include additional overlay nodes. In such an instance, the first manifest 814 may include state IDs of the additional overlay nodes as well. A first manifest state (not shown) is then generated for the first manifest 814 and persistently stored along with the fourth ID 820.

The second state 806 of the base node 402 includes data required to reconstruct the base node 402 (e.g., attributes, properties, etc.) and is persistently stored along with the second ID 808. The second manifest 816 is generated for the base node 402 and has the fifth ID 824 and the storage location of the second state 806 of the base node 402. The second ID 808 of the second state 806 and the fifth ID 824 of the second manifest 816 are the same as the first ID 804 of the first state 802 of the executable interface node 502 (which is also the same as the fourth ID 820 of the first manifest 814 of the executable interface node 502). As mentioned above, along with the first state 802, the first manifest 814 may also be used to identify and retrieve the second manifest 816 which in turn may be used to identify the second state 806 of the base node 402. A second manifest state (not shown) is then generated for the second manifest 816 and persistently stored along with the fifth ID 824. Thus, the states, manifests, and manifest states for the executable interface node 502 and the base node 402 include the same, shared, ID. A shared ID can be used in this instance because the states, manifests, and manifest states are stored separately. The separate storage of the states, manifests, and manifest states exhibit a distributed architecture of the overlay system 202.

The third state 810 of the first overlay node 506 includes data required to reconstruct the first overlay node 506 (e.g., attributes, properties, processing logic, etc.) and is persistently stored along with the third ID 812. The third manifest 818 is generated for the first overlay node 506 and includes the sixth ID 826, which is the same as the third ID 812. Therefore, the first manifest 814 may be further used to identify and retrieve the third manifest 818 which in turn may be used to identify and retrieve the third state 810 of the first overlay node 506. A third manifest state (not shown) is then generated for the third manifest 818 and is persistently stored along with the sixth ID 826.

In operation, when the executable interface node 502 is to be loaded, the transaction module 208, in conjunction with the storage management module 220, may execute one or more operations to retrieve the first manifest state stored at a known storage location. Based on the first manifest state, the storage management module 220 may re-construct the first manifest 814 which includes the fourth ID 820 which is the same as the fifth ID 824 of the second manifest 816. Based on the fifth ID 824, the storage management module 220 may identify the second manifest state and may generate the second manifest 816 based on which the second state 806 is identified. Subsequently, the base node 402 is loaded and the storage management module 220 may determine that the base node is a node with overlay. Based on the fourth ID 820 (that is the same as the first ID 804 of the first state 802 of the executable interface node 502) of the first manifest 814, the first state 802 is identified and retrieved. Subsequently, the executable interface node 502 is loaded. Moreover, based on the overlay ID 822 (that is the same as the sixth ID 826 of the third manifest 818) of the first manifest 814, the third manifest state is identified and the third manifest 818 is generated. Subsequently, based on the sixth ID 826 (that is the same as the third ID of the third state) of the third manifest 818, the third state 810 is identified and retrieved. Based on the third state 810, the first overlay node 506 is reconstructed and loaded in the executable graph-based model 100.

Based on a context of a stimulus (for example, the stimulus 230) associated with the overlay system 202, the processing logic (such as the context module 210) may determine an ID that is the same as the fifth ID 824. Based on the determined ID, the processing logic (such as the memory management module 218 and the storage management module 220) may identify the second manifest 816. Subsequently, the processing logic (such as the memory management module 218 and the storage management module 220) may identify the second state 806 which has the second ID 808 that matches the fifth ID 824. Further, the processing logic (such as the memory management module 218 and the storage management module 220) may retrieve the second state 806 associated with the second manifest 816 from a corresponding storage element. Subsequently, the processing logic (such as the memory management module 218 and the storage management module 220) may determine, by checking the manifest storage(s) associated with the overlay system 202, whether there is another manifest (such as the first manifest of the executable interface node 502) with an ID that matches the second ID 808 and the fifth ID 824. Notably, the first manifest 814 includes storage locations of each overlay node (for example, the first overlay node 506) of the executable interface node 502. Based on the overlay ID 822 included in the first manifest 814 that matches the sixth ID 826 included in the third manifest 818, the processing logic (such as the memory management module 218 and the storage management module 220) may identify and retrieve the third manifest 818 from a manifest storage of a plurality of manifest storages of the overlay system 202. Subsequently, the processing logic (such as the memory management module 218 and the storage management module 220) may identify the third state 810 which has the third ID 812 that matches the sixth ID 826. Further, the processing logic (such as the memory management module 218 and the storage management module 220) may retrieve the third state 810 associated with the third manifest 818 from a corresponding storage element. To determine whether the first overlay node 506 has an overlay node associated therewith, the processing logic (such as the memory management module 218 and the storage management module 220) may also perform a check to determine whether any of the plurality of manifest storages of the overlay system 202 includes any other manifest with an ID that matches the sixth ID 826. Since the first overlay node 506 does not have an overlay associated therewith, no other manifest has the ID that matches the sixth ID.

Notably, the manifest (the third manifest 818) of the first overlay node 506 includes a reference (such as an identifier that is common to the second manifest 816 and the third manifest 818, a link, a path, a storage location, or the like) to the second manifest 816 of the base node 402. Therefore, the re-formation of the executable interface node 502 includes a re-creation of the first overlay node 506 prior to a re-creation of the base node 402. Subsequently, the first overlay node 506 and the base node 402 are organized by associating the base node 402 with the first overlay node 506 to re-form the executable interface node 502.

In some embodiments, the first overlay node 506 may not be loaded in case it is not required for executing the operation associated with the stimulus 230. The loaded executable interface node 502 and the first overlay node 506 may be unloaded in case they remain unused for a predefined time period, whereas one or more executable nodes that are used at least once during the predefined time period may remain loaded in the executable graph-based model 100. In some embodiments, the data and processing logic associated with a loaded executable node and/or overlay node may be transferred to a local memory of the overlay system 202 if the data and the processing logic remain unused for a first predefined period of time. Further, the data and the processing logic associated with the executable node/overlay node are transferred to an external storage from the local memory in case the executable node/overlay node remains unused for a second predefined period of time. The second predefined period of time is greater than the first predefined period of time. The term unloading refers to storing a state of a node with a current version of data and processing logic associated therewith at a storage location in the secondary storage of the storage element that is pointed by the corresponding manifest.

An executable graph-based model (for example, the executable graph-based model 100) may be stored (and loaded) using the above-described composition. Beneficially, each component is stored separately thereby allowing a user to maintain and store their data independently of the storage of the structure and functionality of the executable graph-based model 100.

Notably, the management and storage of manifests is managed by the controller module 206, the memory management module 218, the storage management module 220, a combination of these, or any other module of the overlay system 202. Also, all manifest states are stored together at a storage location (such as a manifest storage) that is known to the storage management module 220. Such centralized storage of the manifest states ensures that node states associated therewith are easily accessible.

It will be apparent to a person skilled in the art that although FIG. 8 illustrates only a single overlay node associated with an interface node, in other embodiments, the executable interface node 502 may include additional or different overlay nodes (for example, the second overlay node 508). It will also be apparent to a person skilled in the art that only those overlay nodes that are required for responding to the stimulus 230 may be loaded.

Additionally, the executable interface node 502 may include two or more identifiers of two or more source nodes associated therewith thereof i.e., two or more active nodes associated therewith. Therefore, based on the loading of the executable interface node 502, the identifiers may be determined and the associated active nodes may be loaded as described above. For example, the interface node 606 may include identifiers of the generic nodes 602 and 604. Therefore, based on the loading of the interface node 606, the generic nodes 602 and 604 may also be loaded. Additionally, based on the interface utility nodes 624 and 626 being parts of the logical structures of the generic nodes 602 and 604, the interface utility nodes 624 and 626 may also be loaded based on the loading of the generic nodes 602 and 604, respectively. In some embodiments, the generic nodes 602 and 604 may include references (for example, storage locations, identifiers, or the like) of the interface utility nodes 624 and 626, respectively. Therefore, based on the loading of the generic nodes 602 and 604, the interface utility nodes 624 and 626, respectively, may also be loaded. In such embodiments, the interface utility nodes 624 and 626 may be loaded based on corresponding references included in the generic nodes 602 and 604, respectively.

It will be apparent to a person skilled in the art that the generic node 302 may be loaded in a manner that is similar to the loading of the base node 402. Additionally, the generic node 302 when extended by way of an overlay node may be loaded in a manner similar to the loading of the executable interface node 502.

In some embodiments, the run-time interface node 426 may be loaded by loading the node template 428 and the node instance 430. Each of the node template 428 and the node instance 430 may be loaded in a manner similar to the loading of the base node 402. A node state of the node instance 430 may include a reference (for example, an identifier, a pointer) to the node template 428. Therefore, the node template 428 may be loaded prior to the loading of the node instance 430. In addition, the node state of the node instance 430 may include a reference (for example, an identifier, a pointer) to node instances of one or more run-time nodes (i.e., source nodes) associated therewith. Based on the reference, the node instances of the one or more run-time nodes may also be loaded. Similarly, a node state of the node template 428 may include a reference (for example, an identifier, a pointer) to node templates of the one or more run-time nodes (i.e., source nodes) associated therewith. Based on the reference, the node templates of the one or more run-time nodes may also be loaded. Based on the loading of the node templates and the node instances, the one or more run-time nodes may be loaded. Additionally, in an instance when the run-time interface node 426 may be extended by way of a run-time overlay node, the node template 428 and the node instance 430 may be associated with overlay node template and overlay node instance, respectively, of the run-time overlay node. In such a scenario, each of the node template 428 and the node instance 430 may be loaded in a manner similar to the loading of the executable interface node 502.

In some embodiments, based on loading of an interface node, active nodes associated therewith may also be loaded. Referring to FIG. 6A, in an instance, when the output of the transaction may be stored in the storage element in association with the overlay node 614, based on the loading of the interface node 606, the overlay node 614 may also be loaded as described in conjunction with FIG. 8. In another instance, when the output of the transaction may be stored in the storage element in association with the generic nodes 602 and 604, based on the loading of the interface node 606, the generic nodes 602 and 604 may also be loaded. Notably, based on the loading of the interface node 608 for use thereof, sources nodes (i.e., the generic nodes 602 and 604) associated therewith may also be loaded.

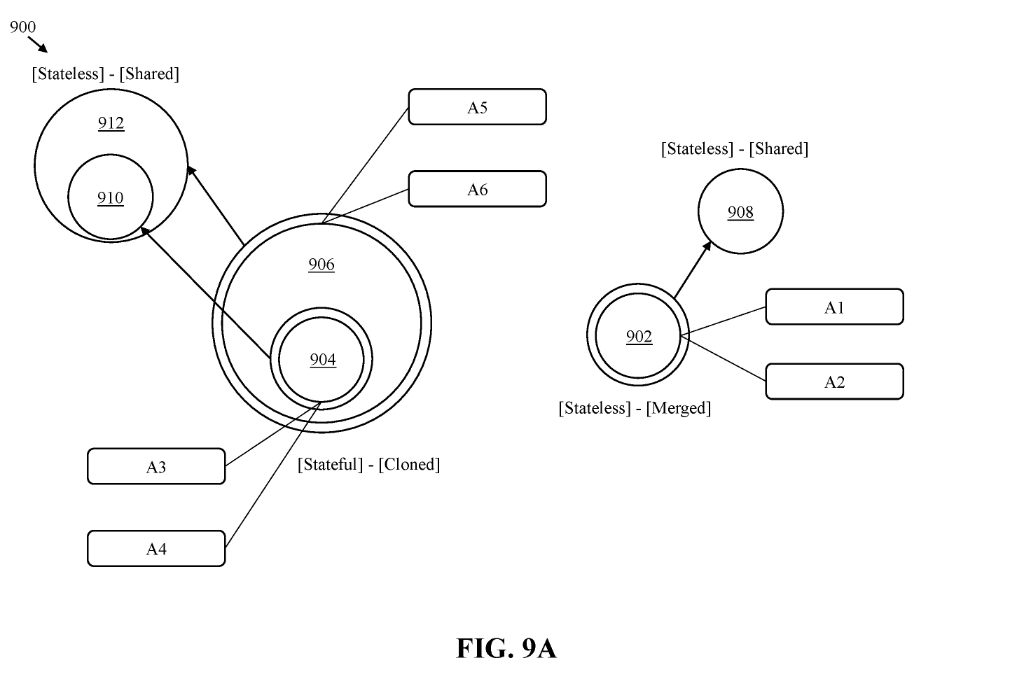

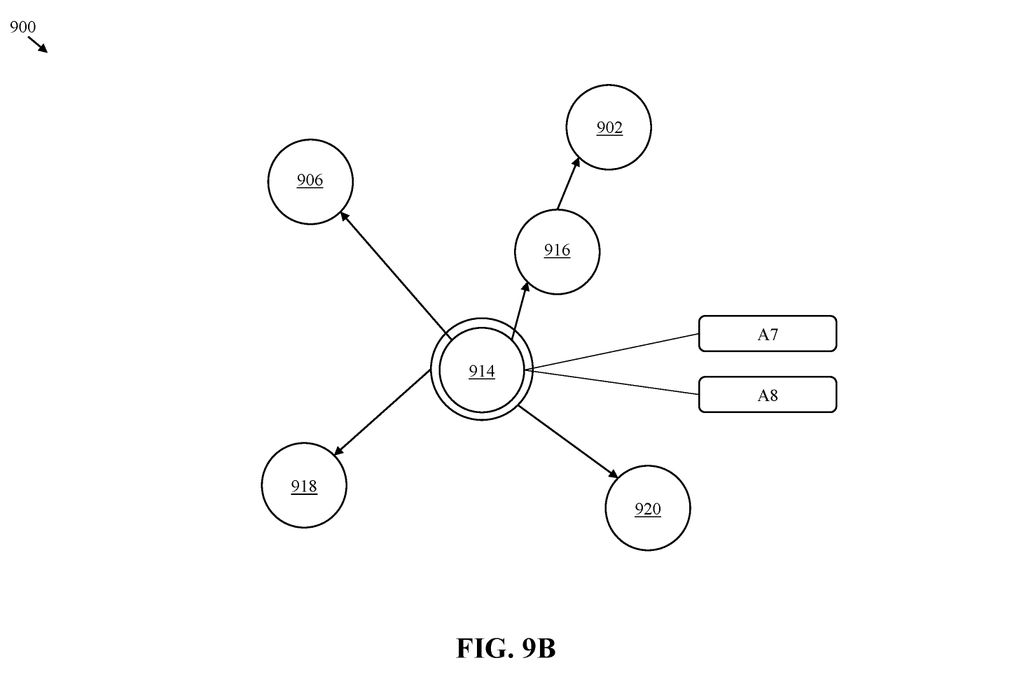

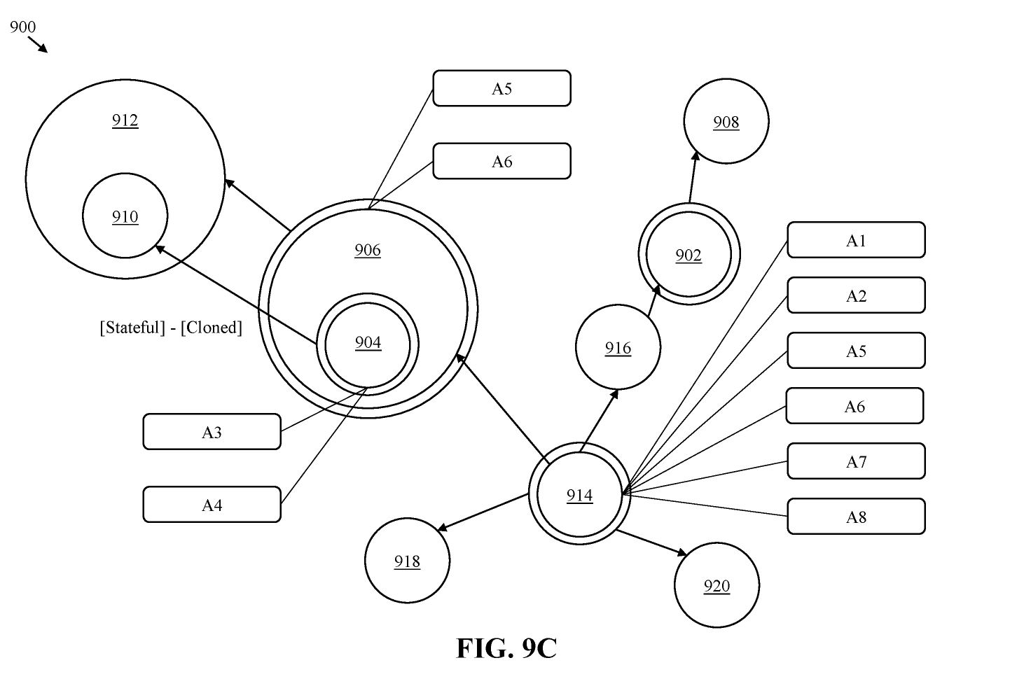

FIGS. 9A-9C, collectively, illustrate a graph 900 that depicts an exemplary implementation of the executable graph-based model 100, consistent with disclosed embodiments of the present disclosure. Referring to FIGS. 9A-9C, illustrated is an exemplary implementation of interface nodes for analyzing the plurality of active nodes in the executable graph-based model 100. The plurality of active nodes may be disparate nodes. The plurality of active nodes may or may not have a commonality therebetween. Throughout the description, the absence of commonality may refer to one or more differences in data, processing logic, purpose, operation, or the like associated with two or more active nodes.

Referring to FIG. 9A, depicted are a plurality of interface nodes implemented in the executable graph-based model 100. The plurality of interface nodes are shown to include an audit interface node 902, a valid interface node 904, and an operation interface node 906. The audit interface node 902, the valid interface node 904, and the operation interface node 906 may, collectively, perform analysis of the plurality of active nodes in the executable graph-based model 100. Each of the plurality of interface nodes may be associated with a corresponding interface definition. An interface definition of an interface node may be indicative of the interface node being the stateless node or the stateful node. In addition, the interface definition may be further indicative of an output approach using which an output of an operation executed using the interface node may be associated with source nodes of the interface node.

As shown, the audit interface node 902 has a third set of attributes associated therewith. The third set of attributes may include attributes A1 and A2. The audit interface node 902 may be further associated with an audit overlay node 908. The audit overlay node 908 may include processing logic that, when executed on attributes of active nodes associated with the audit interface node 902, may generate attribute values for the third set of attributes. In an instance, the attribute A1 may be a ‘Create on’ attribute and the attribute A2 may be a ‘Created by’ attribute. Therefore, when executed on attribute values of the active nodes associated with the audit interface node 902, the audit overlay node 908 may generate attribute values for the attributes A1 and A2. In an instance, the attribute value for the attribute A1 may be determined based on attribute values of a first active node associated with the audit interface node 902. In such an instance, the attribute value of the attribute A1 may be indicative of a date, day, or time at which the first active node may have been created. Similarly, an attribute value for the attribute A2 may be determined based on the attribute values of the first active node associated with the audit interface node 902. The attribute value of the attribute A2 may be indicative of a user, a module of the overlay system 202, or the like that may have created the first active node.

The audit overlay node 908 may be stateless, hence, the attribute values of the attributes A1 and A2 may not be stored in association with the audit overlay node 908. In addition, the audit overlay node 908 may be shared, hence the audit overlay node 908 may be further associated with one or more other interface nodes. The audit interface node 902 may have an interface definition indicative of the audit interface node 902 being the stateless node and an output approach associated therewith being ‘Merged’. Therefore, the attribute values of the attributes A1 and A2 may not be stored in association with the audit interface node 902. In addition, based on the output approach being ‘Merged’, the attribute values of the attributes A1 and A2 may be merged with attributes of the active nodes associated with the audit interface node 902. In other words, the attributes A1 and A2 may be added to a set of attributes of each active node associated with the audit interface node 902. The attributes A1 and A2, in the set of attributes of each active node associated with the audit interface node 902, may have corresponding values as determined by the audit overlay node 908.

As shown, the valid interface node 904 has a fourth set of attributes associated therewith. The fourth set of attributes may include attributes A3 and A4. The valid interface node 904 may be further associated with a valid overlay node 910. The valid overlay node 910 may include processing logic that, when executed on attributes of active nodes associated with the valid interface node 904, may generate attribute values for the fourth set of attributes. In an instance, the attribute A3 may be a ‘Valid from’ attribute and the attribute A4 may be a ‘Valid to’ attribute. Therefore, when executed on the attribute values of the active nodes associated with the valid interface node 904, the valid overlay node 910 may generate attribute values for the attributes A3 and the attribute A4. The attribute values for the attributes A3 and A4, which may have been determined based on the first active node associated with the valid interface node 904, may, collectively, be indicative of a time period within which the first active node is usable and valid within the overlay system 202.

The valid overlay node 910 may be stateless, hence, the attribute values of the attributes A3 and A4 may not be stored in association with the valid overlay node 910. In addition, the valid overlay node 910 may be shared, hence the valid overlay node 910 may be further associated with one or more other interface nodes. The valid interface node 904 may have an interface definition indicative of the valid interface node 904 being the stateful node and an output approach associated therewith being ‘Cloned’. Therefore, the attribute values of the attributes A3 and A4 may be stored in association with the valid interface node 904. In addition, based on the output approach being ‘Cloned’, a copy of the valid interface node 904 or the attribute values of the attributes A3 and A4 may be stored with each of the active nodes associated with the valid interface node 904.

As shown, the operation interface node 906 has a fifth set of attributes associated therewith. The fifth set of attributes may include attributes A5 and A6. The operation interface node 906 may be further associated with an operation overlay node 912. The operation overlay node 912 may include processing logic that, when executed on attributes of active nodes associated with the operation interface node 906, may generate attribute values for the fifth set of attributes. In an instance, the attribute A5 may be a ‘Starts on’ attribute, and the attribute A6 may be an ‘Ends on’ attribute. Therefore, when executed on the attribute values of the active nodes associated with the operation interface node 906, the operation overlay node 912 may generate attribute values for the attributes A5 and the attribute A6. The attribute values for the attributes A5 and A6, which may have been determined based on the first active node associated with the operation interface node 906, may, collectively, be indicative of a time period (for example, an operational window) within which an operation associated with the first active node is to be executed.

The operation overlay node 912 may be stateless, hence, the attribute values of the attributes A5 and A6 may not be stored in association with the operation overlay node 912. In addition, the operation overlay node 912 may be shared, hence the operation overlay node 912 may be further associated with one or more other interface nodes. The operation interface node 906 may have an interface definition indicative of the operation interface node 906 being the stateful node and an output approach associated therewith being ‘Cloned’. Therefore, the attribute values of the attributes A5 and A6 may be stored in association with the operation interface node 906. In addition, based on the output approach being ‘Cloned’, a copy of the operation interface node 906 or the attribute values of the attributes A5 and A6 may be stored with each of the active nodes associated with the operation interface node 906.

As shown, the operation interface node 906 encompasses the valid interface node 904. This indicates that the operation interface node 906 inherits the valid interface node 904. Based on the operational window of the first node being a subset of a time period for which the first active node is valid, the attribute values of the attributes A3 and A4 may be used by the operation interface node 906 to determine the values of the attributes A5 and A6 for the first active node. Based on the operation interface node 906 inheriting the valid interface node 904, the operation interface node 906 inherits data and/or processing logic associated with the valid interface node 904. Therefore, the operation interface node 906 inherits the valid overlay node 910. In other words, as shown by the operation overlay node 912 encompassing the valid overlay node 910, the operation overlay node 912 inherits the valid overlay node 910. Although the operation interface node 906 is depicted herein as the stateful node, in other embodiments, the operation interface node 906 may be the stateless node. That is to say that, the operation interface node 906 may be the stateful node or the stateless node irrespective of the valid interface node 904 being the stateful node or the stateless node.

Referring now to FIG. 9B, shown is the first active node (hereinafter, active node 914) associated with the audit interface node 902 and the operation interface node 906. The active node 914 may be associated with the audit interface node 902 by way of an interface utility node 916. In some embodiments, the active node 914 may be directly associated with an interface node. As shown, the active node 914 is directly associated with the operation interface node 906. In other words, the active node 914 is associated with the operation interface node 906 without an interface utility node acting as a medium therebetween.

The active node 914 may be further associated with overlay nodes 918 and 920. The active node 914 may have a sixth set of attributes associated therewith. The sixth set of attributes may include attributes A7 and A8. In some embodiments, attribute values for the attributes A7 and A8 may be determined based on an execution of the overlay nodes 918 and 920.

For the sake of brevity, only a single active node is shown to be associated with the audit interface node 902 and the operation interface node 906. In practical implementations, each interface node may be associated with multiple active nodes as described throughout the description.

Referring now to FIG. 9C, based on an execution of the processing logic of the audit overlay node 908 on the sixth set of attributes associated with the active node 914, the attribute values for the attributes A1 and A2 may be determined. Further, based on the audit interface node 902 being the stateless node and the output approach being ‘Merged’, the attributes A1 and A2 may be merged with the sixth set of attributes such that the sixth set of attributes further includes the attributes A1 and A2. In other words, the fourth set of attributes may be merged with the sixth set of attributes. The attributes A1 and A2, in the sixth set of attributes, may have corresponding attribute values as determined based on the execution of the processing logic of the audit overlay node 908 on the sixth set of attributes.

The attribute values for the attributes A3 and A4 may be determined based on an execution of the processing logic associated with the valid overlay node 910 on the sixth set of attributes. The processing logic associated with the valid overlay node 910 may be executed by way of the operation interface node 906 inheriting the valid interface node 904. The attribute values of the attributes A3 and A4 may be used by the operation interface node 906 to determine the attribute values for the attributes A5 and A6. The attribute values for the attributes A5 and A6 may be determined further based on execution of the processing logic associated with the operation overlay node 912 on the sixth set of attributes. Subsequently, based on the output approach of the operation interface node 906 being ‘Cloned’ a copy of the fifth set of attributes may be created in association with the active node 914. In other words, a copy/clone of the attributes A5 and A6 may be created in association with the active node 914.

In some embodiments, based on the output approach of the valid interface node 904 being ‘Cloned’ a copy of the fifth set of attributes may also be created in association with the active node 914. In other words, a copy/clone of the attributes A3 and A4 may be created in association with the active node 914.

Based on an application of the plurality of interface nodes in conjunction with the active node 914, the active node 914 may be associated with the sixth set of attributes including the attributes A1, A2, A5, A6, A7, A8, and optionally the attributes A3 and A4. The sixth set of attributes may be used by the overlay system 202 for further analyzing the active node 914. Similarly, one or more active nodes of the plurality of active nodes may also be analyzed. Such an analysis of active nodes may be useful in improving and optimizing the performance of the overlay system 202.

Having discussed the implementation of the interface nodes in the executable graph-based model 100, the description now moves towards a computing system that may be used for such implementations of the interface nodes in the executable graph-based model 100.

FIG. 10 shows an example computing system 1000 for carrying out the methods of the present disclosure, consistent with disclosed embodiments of the present disclosure. Specifically, FIG. 10 shows a block diagram of an embodiment of the computing system 1000 according to example embodiments of the present disclosure.

The computing system 1000 may be configured to perform any of the operations disclosed herein, such as for example, any of the operations discussed with reference to the functional modules described in relation to FIG. 2. The computing system 1000 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 1000 is a distributed system configured to function using multiple computing machines interconnected via a data network or bus system.

The computing system 1000 includes computing devices (such as a computing device 1002). The computing device 1002 includes one or more processors (such as a processor 1004) and a memory 1006. The processor 1004 may be any general-purpose processor(s) configured to execute a set of instructions. For example, the processor 1004 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 1004 may be multiple processing units, a single processing core, multiple processing cores, special purpose processing cores, co-processors, or any combination thereof. The processor 1004 may be communicatively coupled to the memory 1006 via an address bus 1008, a control bus 1010, a data bus 1012, and a messaging bus 1014.

The memory 1006 may include non-volatile memories such as a read-only memory (ROM), a programable read-only memory (PROM), an erasable programmable read-only memory (EPROM), a flash memory, or any other device capable of storing program instructions or data with or without applied power. The memory 1006 may also include volatile memories, such as a random-access memory (RAM), a static random-access memory (SRAM), a dynamic random-access memory (DRAM), and a synchronous dynamic random-access memory (SDRAM). The memory 1006 may include single or multiple memory modules. While the memory 1006 is depicted as part of the computing device 1002, a person skilled in the art will recognize that the memory 1006 can be separate from the computing device 1002.

The memory 1006 may store information that can be accessed by the processor 1004. For instance, the memory 1006 (e.g., one or more non-transitory computer-readable storage mediums, memory devices) may include computer-readable instructions (not shown) that can be executed by the processor 1004. The computer-readable instructions may be software written in any suitable programming language or may be implemented in hardware. Additionally, or alternatively, the computer-readable instructions may be executed in logically and/or virtually separate threads on the processor 1004. For example, the memory 1006 may store instructions (not shown) that when executed by the processor 1004 cause the processor 1004 to perform operations such as any of the operations and functions for which the computing system 1000 is configured, as described herein. Additionally, or alternatively, the memory 1006 may store data (not shown) that can be obtained, received, accessed, written, manipulated, created, and/or stored. The data can include, for instance, the data and/or information described herein in relation to FIGS. 1-9C. In some implementations, the computing device 1002 may obtain from and/or store data in one or more memory device(s) that are remote from the computing system 1000.

The computing device 1002 may further include an input/output (I/O) interface 1016 communicatively coupled to the address bus 1008, the control bus 1010, and the data bus 1012. The data bus 1012 and messaging bus 1014 may include a plurality of tunnels that may support parallel execution of messages by the overlay system 202. The I/O interface 1016 is configured to couple to one or more external devices (e.g., to receive and send data from/to one or more external devices). Such external devices, along with the various internal devices, may also be known as peripheral devices. The I/O interface 1016 may include both electrical and physical connections for operably coupling the various peripheral devices to the computing device 1002. The I/O interface 1016 may be configured to communicate data, addresses, and control signals between the peripheral devices and the computing device 1002. The I/O interface 1016 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, or the like. The I/O interface 1016 is configured to implement only one interface or bus technology. Alternatively, the I/O interface 1016 is configured to implement multiple interfaces or bus technologies. The I/O interface 1016 may include one or more buffers for buffering transmissions between one or more external devices, internal devices, the computing device 1002, or the processor 1004. The I/O interface 1016 may couple the computing device 1002 to various input devices, including mice, touch screens, scanners, biometric readers, electronic digitizers, sensors, receivers, touchpads, trackballs, cameras, microphones, keyboards, any other pointing devices, or any combinations thereof. The I/O interface 1016 may couple the computing device 1002 to various output devices, including video displays, speakers, printers, projectors, tactile feedback devices, automation control, robotic components, actuators, motors, fans, solenoids, valves, pumps, transmitters, signal emitters, lights, and so forth.

The computing system 1000 may further include a storage unit 1018, a network interface 1020, an input controller 1022, and an output controller 1024. The storage unit 1018, the network interface 1020, the input controller 1022, and the output controller 1024 are communicatively coupled to the central control unit (e.g., the memory 1006, the address bus 1008, the control bus 1010, and the data bus 1012) via the I/O interface 1016. The network interface 1020 communicatively couples the computing system 1000 to one or more networks such as wide area networks (WAN), local area networks (LAN), intranets, the Internet, wireless access networks, wired networks, mobile networks, telephone networks, optical networks, or combinations thereof. The network interface 1020 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 1018 is a computer-readable medium, preferably a non-transitory computer-readable medium, comprising one or more programs, the one or more programs comprising instructions which when executed by the processor 1004 cause the computing system 1000 to perform the method steps of the present disclosure. Alternatively, the storage unit 1018 is a transitory computer-readable medium. The storage unit 1018 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 1018 stores one or more operating systems, application programs, program modules, data, or any other information. The storage unit 1018 is part of the computing device 1002. Alternatively, the storage unit 1018 is part of one or more other computing machines that are in communication with the computing device 1002, such as servers, database servers, cloud storage, network attached storage, and so forth.

The input controller 1022 may include suitable logic, circuitry, interfaces, and/or code, executable by the circuitry, that may be configured to control one or more input devices that may be configured to receive an input (the stimulus 230) for the overlay system 202. The output controller 1024 may include suitable logic, circuitry, interfaces, and/or code, executable by the circuitry, that may be configured to control one or more output devices that may be configured to render/output the outcome of the operation executed to process the received input (the stimulus 230).

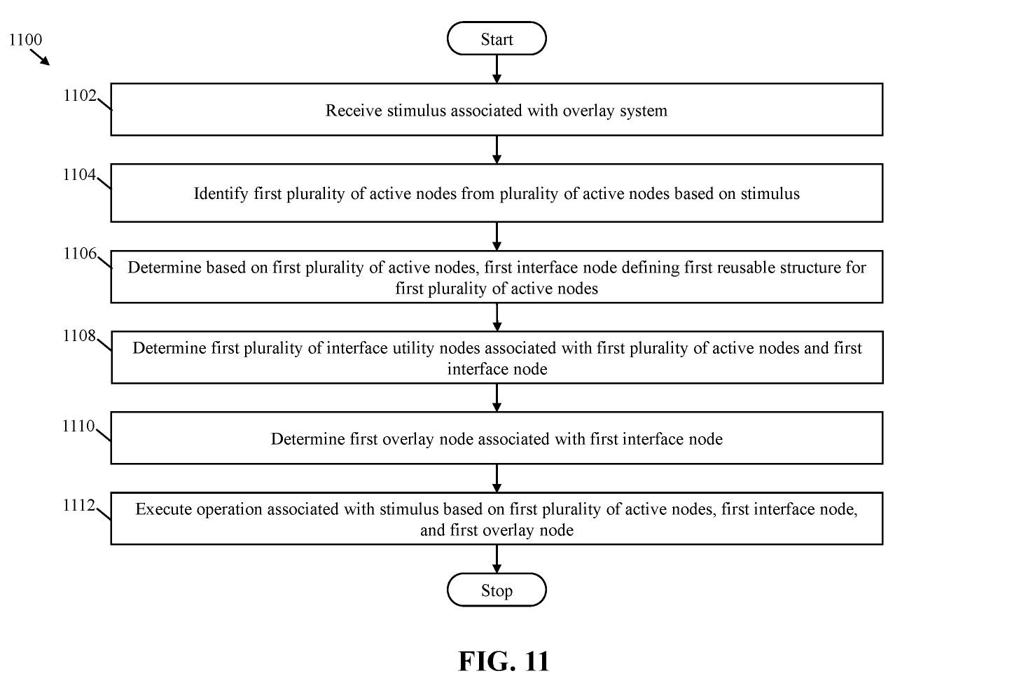

FIG. 11 illustrates a flowchart 1100 of a method for implementing an interface node within the executable graph-based model 100, consistent with disclosed embodiments of the present disclosure. Referring to FIG. 11, at 1102, a stimulus associated with the overlay system 202 may be received. The processing circuitry (such as the controller module 206 and the stimuli management module 212) may receive the stimulus associated with the overlay system 202.

At 1104, a first plurality of active nodes (for example, the generic node 602, the generic node 604, the run-time node 702, and the run-time node 704) from the plurality of active nodes of the executable graph-based model 100 may be identified based on the stimulus. The processing circuitry (such as the controller module 206 and the stimuli management module 212) may identify the first plurality of active nodes from the plurality of active nodes based on a context of the stimulus.

At 1106, a first interface node (for example, the interface node 606 and the run-time interface node 706) defining a reusable structure for the first plurality of active nodes may be determined based on the first plurality of active nodes. The processing circuitry (for example, the controller module 206, the transaction module 208, or the like) may be configured to determine the first interface node.

At 1108, a first plurality of interface utility nodes (for example, the interface utility node 624, the interface utility node 626, the run-time interface utility node 724, and the run-time interface utility node 726) associated with the first plurality of active nodes and the first interface node may be determined from the plurality of interface utility nodes of the executable graph-based model 100. The processing circuitry (for example, the controller module 206, the transaction module 208, or the like) may be configured to determine the first plurality of interface utility nodes. The first plurality of interface utility nodes may act as a medium between the first plurality of active nodes and the first interface node.

At 1110, a first overlay node (for example, the overlay node 614 and the run-time overlay node 714), of a plurality of overlay nodes of the executable graph-based model 100, associated with the first interface node may be determined. The first overlay node may be determined based on a functionality thereof being in conformity with the stimulus. The processing circuitry (for example, the controller module 206, the transaction module 208, or the like) may be configured to determine the first overlay node.

At 1012, an operation associated with the stimulus may be executed based on the first plurality of active nodes, the first interface node, the first plurality of interface utility nodes, and the first overlay node. The processing circuitry (for example, the controller module 206, the transaction module 208, or the like) may be configured to execute the operation based on the first plurality of active nodes, the first interface node, the first plurality of interface utility nodes, and the first overlay node.

The disclosed embodiments encompass numerous advantages including a simple and user-friendly implementation of the executable graph-based model 100 that may be in turn used to implement various complex and advanced applications. The disclosed systems and methods allow for facilitation of active nodes in the executable graph-based model 100. The overlay system 202 disclosed herein resolves the challenges associated with reuse of overlay nodes among disparate nodes by leveraging interface nodes that define and establish reusable, well-defined structures within an executable graph-based model for re-use by the plurality of active nodes. Interface nodes serve as a bridge between different node types, providing a flexible yet standardized framework for managing relationships and interactions between nodes, even those lacking direct connections. This approach removes the inefficiencies and complications that arise from attempting to reuse overlays arbitrarily among unrelated nodes, thereby streamlining the overall system design of the overlay system 202.

By embedding reusable structures within the executable graph-based model 100, the overlay system 202 fosters a modular architecture where components can be developed, reused, or modified independently without impacting the integrity of the executable graph-based model 100. This modularity enhances scalability, as the system can easily adapt to accommodate larger and more complex graphs without a corresponding increase in design complexity. Furthermore, the simplified architecture not only reduces development and maintenance efforts but also improves the clarity of the graph’s operational logic, enabling developers to better understand and optimize the system for a wide range of applications.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for the implementation of a plurality of interface nodes in conjunction with a plurality of active nodes in the executable graph-based models. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:

1. An overlay system, comprising:

a storage element configured to store an executable graph-based model that includes a plurality of active nodes, a plurality of interface nodes, and a plurality of overlay nodes, with each overlay node extending functionality of at least one interface node, the at least one interface node defining a reusable structure for two or more active nodes of the plurality of active nodes, and

processing circuitry configured to:

receive a stimulus associated with the overlay system;

identify, based on the stimulus, from the plurality of active nodes, a first plurality of active nodes;

determine, based on the first plurality of active nodes, a first interface node defining a first reusable structure for the first plurality of active nodes;

determine a first overlay node associated with the first interface node; and

2. The overlay system of 1, wherein the first interface node is determined further based on an absence of an overlay node, having a functionality that conforms to the operation associated with the stimulus, being associated with the first plurality of active nodes.

3. The overlay system of 1, wherein the first overlay node is determined based on processing logic associated therewith conforming to the operation associated with the stimulus.

4. The overlay system of 1,

wherein the executable graph-based model further includes a plurality of interface utility nodes, with each interface utility node being associated with an active node of the plurality of active nodes, and

wherein each interface utility node acts as a medium between the associated active node and one or more interface nodes, of the plurality of interface nodes, that define one or more reusable structures for the associated active node, respectively.

5. The overlay system of 4,

wherein the processing circuitry is further configured to determine, from the plurality of interface utility nodes, a first plurality of interface utility nodes associated with the first plurality of active nodes and the first interface node,

wherein the first plurality of interface utility nodes act as a medium between the first plurality of active nodes and the first interface node, and

wherein the operation is executed further based on the first plurality of interface utility nodes.

6. The overlay system of 1,

wherein the first interface node includes an overlay manager configured to manage the association between the first interface node and the first overlay node,

wherein the processing circuitry is further configured to provide, using the overlay manager, a plurality of attribute values associated with the first interface node to the first overlay node,

wherein the plurality of attribute values include a set of attribute values associated with at least one of the first plurality of active nodes, and

wherein the operation is executed further based on the plurality of attribute values.

7. The overlay system of 1,

wherein the first interface node includes an interface manager configured to facilitate reusability of the first interface node by the first plurality of active nodes,

wherein using the interface manager, the processing circuitry is further configured to:

acquire, from a first active node of the first plurality of active nodes, a first set of attribute values;

map a first attribute ontology of the first active node to a second attribute ontology of the first interface node; and

assign, based on the mapping, the first set of attribute values of the first active node to a first set of attributes associated with the first interface node, and

wherein the operation is executed further based on the assigned first set of attribute values.

8. The overlay system of 7, wherein the operation is executed further based on an application of the first overlay node on the assigned first set of attribute values.

9. The overlay system of 7,

wherein an output of the operation includes a second set of attribute values, and

wherein using the interface manager, the processing circuitry is further configured to assign, based on the mapping, the second set of attribute values to a second set of attributes of the first active node.

10. The overlay system of 1,

wherein the processing circuitry is further configured to identify, based on the stimulus, from the plurality of overlay nodes and the plurality of interface nodes, a second overlay node and a second interface node, respectively,

wherein the second interface node defines a reusable structure for a second plurality of active nodes that includes at least a second active node of the first plurality of active nodes,

wherein the second overlay node is configured to extend functionality of the second interface node, and

wherein the operation is executed further based on the second overlay node and the second interface node.

11. The overlay system of 1, wherein the first interface node is one of a group consisting of a stateless interface node or a stateful interface node.

12. The overlay system of 11, wherein based on the first interface node being the stateless interface node, an output of the operation is stored with the first plurality of active nodes.

13. The overlay system of 11, wherein based on the first interface node being the stateful interface node, an output of the operation is stored with the first interface node.

14. The overlay system of 1,

wherein the first overlay node is one of a group consisting of a stateful overlay node or a stateless overlay node,

wherein the first interface node is one of a group consisting of a stateless interface node or a stateful interface node,

wherein based on the first overlay node being the stateful overlay node and the first interface node being the stateful interface node, an output of the operation is stored with the first overlay node,

wherein based on the first overlay node being the stateful overlay node and the first interface node being the stateless interface node, the output of the operation is stored with the first plurality of active nodes,

wherein based on the first overlay node being the stateless overlay node and the first interface node being the stateful interface node, the output of the operation is stored with the first interface node, and

wherein based on the first interface node being a stateless interface node and the first overlay node being the stateless overlay node, the output of the operation is stored with the first plurality of active nodes.

15. The overlay system of 1,

wherein the processing circuitry is further configured to (i) identify, based on the first interface node, from the plurality of interface nodes, a third interface node that defines a reusable structure for the first interface node, and (iii) determine, from the plurality of overlay nodes, a third overlay node associated with the third interface node, and

wherein the operation is executed further based on the third interface node and the third overlay node.

16. The overlay system of 15,

wherein the executable graph-based model further includes a plurality of interface utility nodes,

wherein the processing circuitry is further configured to determine a second interface utility node, from the plurality of interface utility nodes, associated with the first interface node, and

wherein the second interface utility node acts as a medium between the first interface node and the third interface node.

17. The overlay system of 15, wherein, based on the third interface node defining the reusable structure for the first interface node and the association of the third interface node with the third overlay node, the processing circuitry is further configured to execute processing logic of the third overlay node on the first plurality of active nodes.

18. The overlay system of 1,

wherein the processing circuitry is further configured to identify, for processing the stimulus, from the plurality of interface nodes, one or more interface nodes inherited by the first interface node, and

wherein the operation is executed further based on the one or more interface nodes.

19. The overlay system of 18,

wherein the one or more interface nodes are associated with one or more overlay nodes of the plurality of overlay nodes, respectively, and

wherein the operation is executed further based on the one or more overlay nodes associated with the one or more interface nodes.

20. The overlay system of 1, wherein prior to the execution of the operation, the processing circuitry is further configured to:

determine whether at least one of a group consisting of: the first interface node, the first plurality of active nodes, or the first overlay node is unloaded from the executable graph-based model; and

load, based on the determination of at least one of the group consisting of: the first interface node, the first plurality of active nodes, or the first overlay node being unloaded from the executable graph-based model, at least one of the group consisting of: the first interface node, the first plurality of active nodes, or the first overlay node, in the executable graph-based model.

21. The overlay system of 1,

wherein the first interface node is further associated with a second overlay node of the plurality of overlay nodes,

wherein a functionality of the second overlay node conforms with the operation associated with the stimulus, and

wherein the operation is executed further based on the second overlay node.

22. The overlay system of 1, wherein an active node of the first plurality of active nodes is one of a group consisting of an edge node, a vertex node, a role node, or an overlay node.

23. The overlay system of 1, wherein an active node of the first plurality of active nodes is a generic node, and the first interface node is a generic interface node.

24. The overlay system of 1,

wherein an active node of the first plurality of active nodes is a run-time node including (i) a node template that is a predefined node structure and (ii) a node instance that is an implementation of the node template, and

wherein the first interface node is a run-time interface node having (i) an interface node template that is a predefined interface node structure and (ii) an interface node instance that is an implementation of the interface node template.

25. The overlay system of 24, wherein the processing circuitry is further configured to:

load the run-time node based on loading of the corresponding node template and the corresponding node instance; and

load the run-time interface node based on loading of the interface node template and the interface node instance.

26. A method, comprising:

receiving, by processing circuitry, a stimulus associated with an overlay system;

wherein an executable graph-based model is stored in a storage element of the overlay system, and

wherein the executable graph-based model includes a plurality of active nodes, a plurality of interface nodes, and a plurality of overlay nodes, with each overlay node extending functionality of at least one interface node, the at least one interface node defining a reusable structure for two or more active nodes of the plurality of active nodes;

identifying, by the processing circuitry, a first plurality of active nodes from the plurality of active nodes based on the stimulus;

determining, by the processing circuitry, based on the first plurality of active nodes, a first interface node defining a first reusable structure for the first plurality of active nodes;

determining, by the processing circuitry, a first overlay node associated with the first interface node; and

executing, by the processing circuitry, an operation associated with the stimulus based on the first plurality of active nodes, the first interface node, and the first overlay node.

What is claimed is:

1. An overlay system, comprising:
a storage element configured to store an executable graph-based model that includes a plurality of active nodes, a plurality of interface nodes, and a plurality of overlay nodes, with each overlay node extending functionality of at least one interface node, the at least one interface node defining a reusable structure for two or more active nodes of the plurality of active nodes; and
processing circuitry configured to:
receive a stimulus associated with the overlay system;
identify, based on the stimulus, from the plurality of active nodes, a first plurality of active nodes;
determine, based on the first plurality of active nodes, a first interface node defining a first reusable structure for the first plurality of active nodes;
determine a first overlay node associated with the first interface node; and
execute an operation associated with the stimulus based on the first plurality of active nodes, the first interface node, and the first overlay node.

2. The overlay system of claim 1, wherein the first interface node is determined further based on an absence of an overlay node, having a functionality that conforms to the operation associated with the stimulus, being associated with the first plurality of active nodes.

3. The overlay system of claim 1, wherein the first overlay node is determined based on processing logic associated therewith conforming to the operation associated with the stimulus.

4. The overlay system of claim 1,
wherein the executable graph-based model further includes a plurality of interface utility nodes, with each interface utility node being associated with an active node of the plurality of active nodes, and
wherein each interface utility node acts as a medium between the associated active node and one or more interface nodes, of the plurality of interface nodes, that define one or more reusable structures for the associated active node, respectively.

5. The overlay system of claim 4,
wherein the processing circuitry is further configured to determine, from the plurality of interface utility nodes, a first plurality of interface utility nodes associated with the first plurality of active nodes and the first interface node,
wherein the first plurality of interface utility nodes act as a medium between the first plurality of active nodes and the first interface node, and
wherein the operation is executed further based on the first plurality of interface utility nodes.

6. The overlay system of claim 1,
wherein the first interface node includes an overlay manager configured to manage the association between the first interface node and the first overlay node,
wherein the processing circuitry is further configured to provide, using the overlay manager, a plurality of attribute values associated with the first interface node to the first overlay node,
wherein the plurality of attribute values include a set of attribute values associated with at least one of the first plurality of active nodes, and
wherein the operation is executed further based on the plurality of attribute values.

7. The overlay system of claim 1,
wherein the first interface node includes an interface manager configured to facilitate reusability of the first interface node by the first plurality of active nodes,
wherein using the interface manager, the processing circuitry is further configured to:
acquire, from a first active node of the first plurality of active nodes, a first set of attribute values;
map a first attribute ontology of the first active node to a second attribute ontology of the first interface node; and
assign, based on the mapping, the first set of attribute values of the first active node to a first set of attributes associated with the first interface node, and
wherein the operation is executed further based on the assigned first set of attribute values.

8. The overlay system of claim 7, wherein the operation is executed further based on an application of the first overlay node on the assigned first set of attribute values.

9. The overlay system of claim 7,
wherein an output of the operation includes a second set of attribute values, and
wherein using the interface manager, the processing circuitry is further configured to assign, based on the mapping, the second set of attribute values to a second set of attributes of the first active node.

10. The overlay system of claim 1,
wherein the processing circuitry is further configured to identify, based on the stimulus, from the plurality of overlay nodes and the plurality of interface nodes, a second overlay node and a second interface node, respectively,
wherein the second interface node defines a reusable structure for a second plurality of active nodes that includes at least a second active node of the first plurality of active nodes,
wherein the second overlay node is configured to extend functionality of the second interface node, and
wherein the operation is executed further based on the second overlay node and the second interface node.

11. The overlay system of claim 1,
wherein the first interface node is one of a group consisting of a stateless interface node or a stateful interface node,
wherein based on the first interface node being the stateless interface node, an output of the operation is stored with the first plurality of active nodes, and
wherein based on the first interface node being the stateful interface node, the output of the operation is stored with the first interface node.

12. The overlay system of claim 1,
wherein the first overlay node is one of a group consisting of a stateful overlay node or a stateless overlay node,
wherein the first interface node is one of a group consisting of a stateless interface node or a stateful interface node,
wherein based on the first overlay node being the stateful overlay node and the first interface node being the stateful interface node, an output of the operation is stored with the first overlay node,
wherein based on the first overlay node being the stateful overlay node and the first interface node being the stateless interface node, the output of the operation is stored with the first plurality of active nodes,
wherein based on the first overlay node being the stateless overlay node and the first interface node being the stateful interface node, the output of the operation is stored with the first interface node, and
wherein based on the first interface node being the stateless interface node and the first overlay node being the stateless overlay node, the output of the operation is stored with the first plurality of active nodes.

13. The overlay system of claim 1,
wherein the processing circuitry is further configured to (i) identify, based on the first interface node, from the plurality of interface nodes, a third interface node that defines a reusable structure for the first interface node, and (iii) determine, from the plurality of overlay nodes, a third overlay node associated with the third interface node, and
wherein the operation is executed further based on the third interface node and the third overlay node.

14. The overlay system of claim 13,
wherein the executable graph-based model further includes a plurality of interface utility nodes,
wherein the processing circuitry is further configured to determine a second interface utility node, from the plurality of interface utility nodes, associated with the first interface node, and
wherein the second interface utility node acts as a medium between the first interface node and the third interface node.

15. The overlay system of claim 1,
wherein the processing circuitry is further configured to identify, for processing the stimulus, from the plurality of interface nodes, one or more interface nodes inherited by the first interface node, and
wherein the operation is executed further based on the one or more interface nodes.

16. The overlay system of claim 15,
wherein the one or more interface nodes are associated with one or more overlay nodes of the plurality of overlay nodes, respectively, and
wherein the operation is executed further based on the one or more overlay nodes associated with the one or more interface nodes.

17. The overlay system of claim 1, wherein prior to the execution of the operation, the processing circuitry is further configured to:
determine whether at least one of a group consisting of: the first interface node, the first plurality of active nodes, or the first overlay node are unloaded from the executable graph-based model; and
load, based on the determination of at least one of the group consisting of: the first interface node, the first plurality of active nodes, or the first overlay node being unloaded from the executable graph-based model, at least one of the group consisting of: the first interface node, the first plurality of active nodes, or the first overlay node, in the executable graph-based model.

18. The overlay system of claim 1,
wherein an active node of the first plurality of active nodes is a run-time node including (i) a node template that is a predefined node structure and (ii) a node instance that is an implementation of the node template, and
wherein the first interface node is a run-time interface node having (i) an interface node template that is a predefined interface node structure and (ii) an interface node instance that is an implementation of the interface node template.

19. The overlay system of claim 18, wherein the processing circuitry is further configured to:
load the run-time node based on loading of corresponding node template and corresponding node instance; and
load the run-time interface node based on loading of the interface node template and the interface node instance.

20. A method, comprising:
receiving, by processing circuitry, a stimulus associated with an overlay system;
wherein an executable graph-based model is stored in a storage element of the overlay system, and
wherein the executable graph-based model includes a plurality of active nodes, a plurality of interface nodes, and a plurality of overlay nodes, with each overlay node extending functionality of at least one interface node, the at least one interface node defining a reusable structure for two or more active nodes of the plurality of active nodes;
identifying, by the processing circuitry, a first plurality of active nodes from the plurality of active nodes based on the stimulus;
determining, by the processing circuitry, based on the first plurality of active nodes, a first interface node defining a first reusable structure for the first plurality of active nodes;
determining, by the processing circuitry, a first overlay node associated with the first interface node; and
executing, by the processing circuitry, an operation associated with the stimulus based on the first plurality of active nodes, the first interface node, and the first overlay node.
